(19) United States
(12) Patent Application Publication
(10) Pub. No.: US 2018/0018714 A1
(43) Pub. Date: Jan. 18, 2018

(54) SYSTEM AND METHOD OF DELIVERING ADVERTISING OVER NETWORKS

(71) Applicants: David A. Uhalley, Novato, CA (US); Brian H. Boyajian, Petaluma, CA (US)

(72) Inventors: David A. Uhalley, Novato, CA (US); Brian H. Boyajian, Petaluma, CA (US)

(21) Appl. No.: 15/663,479

(22) Filed: Jul. 28, 2017

Related U.S. Application Data
(63) Continuation-in-part of application No. 15/191,397, filed on Jun. 23, 2016.
(60) Provisional application No. 62/368,652, filed on Jul. 29, 2016.
(60) Provisional application No. 62/183,587, filed on Jun. 23, 2015.

(51) Int. Cl. G06Q 30/02; H04L 29/08; H04N 21/81; H04N 21/2187; H04L 12/58

(52) U.S. Cl. CPC G06Q 30/0277; H04L 67/306; G06Q 30/0269; G06Q 30/0248; H04L 51/04; H04N 21/2187; H04N 21/812

(57) ABSTRACT

A method of online advertising in a communications network in which an advertiser's teaser is presented with real-time content and communications features activated to an end user using a network connected device on a publisher's site or channel, but only when a channel associated with the advertiser's teaser is live.

### CROSS REFERENCES TO RELATED APPLICATIONS

The present application claims the benefit of the filing date of U.S. Provisional Patent Application Ser. No. 62/368,652, filed Jul. 29, 2016 (Jul. 29, 2016), and is a continuation-in-part U.S. patent application Ser. No. 15/191,397, filed Jun. 23, 2016 (Jun. 23, 2016), which claims the benefit of the filing date of U.S. Provisional Patent Application Ser. No. 62/183,587, filed Jun. 23, 2015 (Jun. 23, 2015), all of which are incorporated in their entirety by reference herein.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### BACKGROUND OF THE INVENTION

### Field of the Invention

The present invention relates most generally to advertising, and more particularly to on-line advertising, and still more particularly to a system and method of internet-enabled advertising and marketing wherein a teaser ad component of a publisher's advertisement can be presented with real-time communications features and content, but only when the publisher's associated channel is live.

### Background Discussion

The internet has effectively eclipsed all other media for promoting goods and services. There is, however, growing evidence indicating that many online advertisements remain either unnoticed, or in many cases, are considered to be annoyances that are thus consciously and purposefully ignored by the end user. Originally, online advertising involved only text. Later, banner ads were introduced, which included still artwork design and photographs. Eventually, the artwork was animated or otherwise made dynamic so that the movement would attract and keep a viewer's attention. The most recent online trend is video advertising, and it is growing at a rapid rate. Regardless of the type of advertisement displayed, there have been few significant changes with regard to what happens after an end user selects (e.g., “clicks” on) a displayed advertisement, and then in how the ad content is presented to—and communicated with—the end user.

### BRIEF SUMMARY OF THE INVENTION

In an aspect, it will be seen that the present invention involves methods of delivering, measuring, managing, and displaying, live advertisements (“LivingAds”) that are easily accessible and highly engaging. LivingAds content is available in real-time, offering a truly immersive and inherently human, thus natural experience for the end user. Online real-time communications are quickly becoming mainstream and are readily available, providing an opportunity for a unique and highly effective online advertising system and method.

The invention employs a real-time communications (“RTC”) System, which provides unique methods ideally suited for online advertising. These benefits directly affect all those involved in an online advertisement lifecycle: the end user, the advertiser, and the publisher; and they include online networks (social networks and others) hosting sophisticated online advertising networks of their own. The system is designed for real-time communications from the ground up, and because of its customized and unique RTC architecture, it offers such advertising methods in ways that conventional advertising systems simply cannot.

Conventional internet advertising does not involve actual live person(s) and/or experiences associated with the ads. Most traditional online ads, when selected, direct the end user to the advertiser's website or to an external, third-party web page that cannot support real-time communications. For this reason, many of the features offered by the present invention would be difficult or impossible to achieve without having access, and taking full advantage, of the unique properties of the inventive RTC system.

The system is also designed to closely mimic the real world experience, insofar as the inventive methods offer real-time communications features found in everyday real world events, activities, and engagements. The system and its methods allow for this real world experience and then enhance that experience with unique online features. Mixing the “traditional” real world communications model with internet communications methods results in a powerful hybrid, offline/online, real-time communications system that is powerful, flexible, and truly unique.

The inventive system and methods, however, are compatible with conventional closed, open, and hybrid online platforms and networks. The system and methods of the present invention are also compatible with traditional, and modern, online advertising platforms, networks and methods. The system is not inextricably tied to browser-based technologies. On the contrary, it is suited for use with native apps, television, messaging platforms, and other platforms not dependent on browsers.

Among the many advantages of the present invention, first and foremost, the Living Ad live teaser only appears when its associated channel is live. The channel online/offline control option is a crucial component of the proposed invention. If the channel associated with a teaser ad is set to offline, the live teaser ad will not display on a publisher's site or channel. The live teaser ad may deactivate or convert to its default static teaser ad state as soon as its associated channel is switched to offline, resulting in extra incentive for an interested end user to select the teaser before it's potentially no longer available. The live teasers can be configured to run on a first-come/first-served, basis, along with a maximum capacity set.

An advertiser can control how many of its live teasers are displayed. Once the maximum impressions and/or “click-thrus” are reached, the live teaser “times out” and self-destructs on the publisher, or converts to its default static teaser ad state.

The advertiser can also set limits on how many products and/or services are being sold, and the live teaser advertisement can self-destruct on the publisher once that limit is reached, or converts to its default static teaser ad state.

A counter can be included on a live teaser ad, notifying end users how many items are left. Or, the number of items remaining for sale can remain unknown to the end user; providing additional incentive for an interested end user to click-thru before the teaser disappears on the publisher.

The advertiser also has control over the number of simultaneous end users (number of current click-thrus and/or regular viewers) with RTC privileges on its channel. As soon as an end user who has been granted RTC privileges leaves a channel, another live teaser advertisement can be displayed, only allowing a predetermined set number of end users with RTC privileges on the channel at a time. Referred to as the “revolving door” method, the method involves: one person out, one person in, and this can be ongoing until the maximum number of live teaser ad click-thrus or CPMs (cost per 1,000 impressions) are reached. It should be noted that this “revolving door” method closely resembles the real world experience as mentioned in the Introduction of this document. As with a brick and mortar store, channels also have control over the number of simultaneous visitors. (See FIGS. 3-5, and FIG. 8, described fully below.)

The advertiser, as part of the LivingAds campaign, can also be granted (by the System) a prearranged set of RTC features and/or tools based on a type of promotion. For example, some advertisers may wish to present a live video broadcast while others may prefer individually-selected video and/or audio chats, telepresence, or IM.

The advertiser's channel, by default, can begin with pure peer-to-peer (P2P) communications and convert to broadcast, along with media server(s), based on the amount of traffic. This on-demand media server method, specifically geared for online advertising, is truly unique and very effective. As used herein, “broadcast” bears the meaning of transmitting from one to many.

A LivingAds advertising campaign can also be dynamic, and easily scalable, based on the type of advertisement experience being presented on its associated channel.

End users can be presented with opportunities to win rewards and/or prizes if they click-thru the live teaser to experience the ad content on its associated channel. This type of ad gamification is unique and an incredibly effective marketing strategy, particularly due to its RTC features.

Advertisers have control over their teaser ad “roll out” frequency rates. For example, some advertisers, particularly those opting for pure P2P communications, may wish to limit to a bare minimum the number of end users simultaneously on their channels. In these cases, they can set their live teasers to be released on a slower roll out rate in relation to advertisers who wish to broadcast to a large number of end users simultaneously on their channel, such teasers being released to publishers on a more rapid roll out scheduling rate. Live teaser ads can also be adjusted to roll out to publishers only when their associated channel has not reached the maximum number of simultaneous end users with RTC privileges. (See FIGS. 6-8.)

Advertisers have control over the amount of time a teaser is displayed on a publisher. Such control enables an advertiser to ensure that end users never know, for example, exactly how long a live teaser ad will be available, thus providing an extra incentive for those end users truly interested in the teaser ad to click-thru.

Advertisers have control over the amount of time they allow the end user to view their channels. Special conditions can also be arranged. For example, if an end user participates in RTC, including instant messaging (IM), his or her time allowed on the channel may be increased or the time limit may no longer apply. As with all the channel configurations (with or without advertising), the channel provider is in full control. This method prevents end users from sitting idle on channels and potentially preventing others from experiencing the advertiser's content, much as with the “revolving door” method previously described.

Teaser ads can be requested by end users. The advertiser(s) can accept or deny any end user, based on the user profile, or for any other reason. If the request is accepted, the teasers can be released at any time to the specific end users requesting them.

Invitations can be sent out by advertisers to specific end users based on their profiles. An RSVP can be included as part of the invitation and either accepted or denied by the end user for any reason. If the invitation is accepted, the teaser ads can be released at any time to the specific end users agreeing to receive them.

As with real world seminars and online webinars, questions asked on an advertiser's channel can be handled by operators and addressed selectively before, during, or after the ad broadcast has completed. In some cases, interaction may not be necessary such as during special live events.

As with conventional online advertising methods, teasers can be location based. Using geolocation technologies, including end users' IP addresses, different advertisements can be displayed on the publisher at the same time, and based on the end user's location. However, unlike conventional advertising methods, LivingAds live teasers are always live and offer an enhanced experience for the end user, regardless of location. Ultimately, LivingAds offer a more intimate experience with the advertiser's product, no matter where the end user resides.

Accessing a promotion featuring such RTC options is particularly unique and advantageous for manipulating and/or operating remote physical devices (“telepresence”) associated with the advertisement. Such physical objects can include digital cameras, robots, and/or any electronic mobile device. The system architecture permits easy access, along with control, of network-connected devices, offering an end user a unique perspective of the advertiser's product, whether in the real world, in a virtual reality landscape, and/or an augmented reality environment. (See FIGS. 11-12)

With conventional advertising, the end user is essentially a spectator of a polished, often unrealistic, representation of a product and/or service. With LivingAds, the end user becomes an actual participant in the advertisement. The advertiser can no longer fully control how an advertisement is seen by prospective buyers. Instead, the end user is now in charge of how he views the product being promoted. This is a significant change in how the internet-based advertising world operates.

With the present invention, advertisers are forced into being more transparent and honest with customers, especially on advertising channels where end users have the option of directing the advertisement. The result: a more level playing field where not only the advertisers with the largest ad campaigns thrive. Instead, advertisers that are most open and honest about their products are more likely to succeed, regardless of the size of their advertising budgets. Advertisers caught being deceptive will lose market share quickly, particularly in a real-time communications environment such as this proposed invention. “Live cameras don't lie.” The consumer now has an advantage, and advertisers must conform to this new (marketing) reality.

Selected and/or random end users can be chosen (by the advertiser) to have a telepresence option available on an associated channel, (see FIGS. 11-12).

LivingAds assist in converting push advertising into pull advertising. End users will recognize, and embrace, the trust factor associated with products promoted using these proposed advertising methods. Ultimately, customers will seek out products they recognize being advertised as LivingAds.

Ad measurement methods: Advertisers can track, in real-time, individual end user behavioral patterns.

Advertisers, on membership-based websites, can instantly be provided with information on (logged in) end users entering their associated channel.

Advertisers on membership-based websites can target end users demographically based on their user profiles.

End users, including those who are not logged in on membership-based sites, are immediately recognized when entering an advertiser's channel. Real-time communications, under channel provider discretion, are immediately available to the end user, without any login, downloads, installs, and/or special privileges when entering a channel. It should be noted that in some scenarios the ad viewer may need to download and install software in order to experience RTC with the inventive system. This may be a download via the browser (plugin) or native mobile app install, or even pre-installed (out of the box) in the electronic device itself.

Ad management methods: Advertisers can make real-time adjustments based on individual end user behavioral patterns. For example, teasers can be personalized and targeted to specific end users, resulting in customized ads—“quality vs. quantity”—as opposed to bulk ad campaigns used in conventional online advertising campaigns. Though it must be noted that LivingAds can promote bulk ad campaigns as well.

The inventive system contains network condition-based algorithms that factor in and adjust LivingAds-related data accordingly, all in real-time. Poor network conditions, primarily, affect those ads (and associated channels) that rely strictly on core peer-to-peer communications. With this proactive method in place, channels are notified in real-time of any network-related issues, allowing them to adjust how they present their promotions. The algorithms factor in dynamic network conditions and make the same, or similar, accommodations for channels broadcasting live and using media servers. Channels can notify their customers in real-time of current network conditions. The types of LivingAds can be adjusted in real-time based on network conditions. The number of those ads can be adjusted in real-time based on network conditions. (See FIGS. 9, 10.) The display of those ads can be adjusted in real-time based on network conditions. The cost of those ads can be adjusted in real-time based on network conditions.

Micropayment options are offered to all advertisers. Micropayments are particularly beneficial for advertisers that may fall under the “classifieds” type of promotions. These types of small budget advertisers don't have the volume of traffic on their associated channels compared to the larger, live broadcast, types of advertisements. LivingAds, however, are ideal for smaller ad campaigns, including “classifieds” type ads. Micropayments, as a result, offer an affordable option for those ad campaigns that depend on core P2P advertising.

Core P2P advertising is also facilitated and is more advantageous using the present invention, because the consumer purchases products and/or services directly from the source, with no middleman involved. The result is a quicker, more informative, and transparent/honest transaction. The ability of the system to offer 1-1 real-time advertising communications is truly unique to the internet, yet similar to real world occurrences. Furthermore, pure P2P communications are inherently more secure than those in the traditional client/server architecture.

The size, type, or even placement of LivingAds are insignificant compared to conventional online ads. Video advertising has proven to be an effective type of display advertising because of their ability to grab the end user's attention but, end users observing display ads, beyond brand awareness, really don't provide much benefit for the advertiser. The advertiser's goal is for the end user to select the ad, and make the purchase. The proposed teaser ads can be in any display format. However, once an end user recognizes that any Living Ad live teaser, when selected, results in a live feed, the size or type of ad does not matter.

Live teasers can be shown as a live video feed, unlike current ad promotions showing taped video or stills. This type of ad display will prove to be much more effective than standard video advertising.

Pricing can be adjusted per type of teaser ad display, with text teasers being the least expensive and live video teasers being the most expensive.

Core P2P online advertising is, technically, more simple than conventional online advertising. When there is no use of a media server, communication between advertiser and the end user is direct, client-to-client.

From a business perspective, core P2P advertising using the present invention is more cost effective than standard online advertising because there is little to no hosting costs involved.

Summarily stated, LivingAds translates into a dignified advertising model that respects end users by presenting their promotion in a live and transparent format, thereby greatly diminishing the chance of any false or deceptive advertising. Showing respect for the end user will be reciprocally returned to the advertiser who will be supported for being so open with promotions. The publisher will also be appreciated by guests for running such teaser ads.

In short, LivingAds provide the incentive for click-thrus, and the methods for communicating with the customer, in a real-time environment. This vastly increases the advertiser's chances at making a sale.

In the most general terms, there are five principal aspects of the present invention that make it unique and, ultimately, a better “System and Method of Delivering Advertising Over Networks”:

First, live teasers may be served, but teasers can also be served static—and change to live when an advertiser goes live on its channel. In some cases, RTC can be achieved directly in the live teaser ad itself without the Ad Viewer (End User) having to select the teaser.

Second, the RTC System(s) are designed from the ground up for live online advertising.

Third, the system uses push technology, wherein the advertiser triggers the live teaser ad being served—and/or—the static teaser already served can convert to live (be activated) with the trigger being the advertiser going live on its channel or the advertiser's respective channel going live. A common way to describe such a system is a dynamic electronic advertising communications switchboard.

Fourth, the RTC-related methods, including, but not limited to, the Revolving Door, Ad Viewer Validation, Anti-Click Fraud, Real-Time Ad Gamification, and Real-Time Ad Metrics methods, as described in the Detailed Description that follows.

Fifth, the inventive system employs a blend of “traditional” real world communications model with internet communications methods, results in a hybrid, online/offline communications system that is powerful, flexible, and truly unique.

Technology Solution:

The following five distinct technology components play significant roles in the inventive system, but the sum of these components—the synergistic combination of technologies and methods applied to these technologies—truly make the invention commercially and practically advantageous.

LivingAds Portal: allows for advertisers to register and manage RTC settings (related to RTC Ad Rules Engine, below); including login to go live on their channels. It can also serve as the advertiser's RTC channel during live engagements with ad viewers (referred to as ad “content details” in the provisional).

LivingAds Ad Server: responsible for serving the teasers and/or advertiser's availability status appearing on the teaser ad.

RTC Server: responsible for all RTC-related functionalities; including, but not limited to: coordinating the signaling of setting up the IM/audio/video call between the ad viewer and the advertiser, as well as setting the appropriate status of the advertiser. WebRTC (Web Real-Time Communications) is the preferred browser-based peer-to-peer (P2P) technology for the present invention; however, the system is not limited to this technology and can utilize other real-time communications technologies. For example, for broadcast (one-to-many) streaming, media servers, along with other technologies such as DASH (Dynamic Adaptive Streaming over HTTP), HLS (HTTP Live Streaming), and SFU (Selective Forwarding Unit) can be utilized in conjunction with WebRTC or on their own, or even other RTC technologies. Further, the system is not in any way dependent on a single RTC solution or RTC vendor. Rather, multiple RTC solutions and/or vendors may be involved in the overall system, depending on the application.

RTC Ad Rules Engine: Provides advertisers with a number of unique communications controls, based on their RTC settings, to manage their ad campaigns. Ultimately, the RTC Ad Rules Engine governs how, when, what, and where teaser ads are served.

WebSocket connection: The persistent bilateral communication established between the end user, as well as advertiser, and LivingAds Network is absolutely critical, especially with respect to online live advertising. This uninterrupted connection ensures delivery of truly real-time ads. Permitting ongoing and real-time data transfer between the browser (end user and advertiser), and/or mobile app, and the LivingAds network is mandatory as a true RTC Advertising system. It also enables dynamic capabilities, before, during, and after the teaser is selected, that are absolutely essential to the RTC system as a whole, and its associated methods described in this application.

Live online advertising is dependent on a genuine RTC system. Without a designated RTC system, the result is static advertising—i.e., bad advertising—with the user left waiting for an advertiser to appear; an effect entirely opposite that desired by an advertiser paying to run a promotion. The present invention, with its systems and its unique methods, creates a powerful and effective solution, ideal for live online advertising.

The foregoing summary broadly sets out the more important features of the present invention so that the detailed description that follows may be better understood, and so that the present contributions to the art may be better appreciated. There are additional features of the invention that are described in the detailed description of embodiments of the invention and which form the subject matter of claims set out herein.

### Glossary

Real-Time Communications Components Defined:

System: An online real-time communications platform comprising dedicated and/or ephemeral channels. The System is not limited to run on just one website or network. The system can be licensed to run on independent networks, or even appearing to run independently on external websites or networks through the use of white labeling options.

Channel: Advertisement content details (product and/or service) are displayed here, only if the channel is associated with a Living Ad. The channel consists of, but is not limited to, real-time communication tools such as instant messaging (text), audio, video, and built-in telepresence capabilities for remote manipulation of physical devices. The channel resides within the aforementioned real-time communications system. All “teaser ads”, see below, must have an associated channel, internal to a set website and/or network, or external, potentially as an independent white label web page, and/or network. The channel may be dedicated, but it may also be ephemeral, enduring only for the duration of the Living Ad. Thus, there are two types of channels: one dedicated and going live, wherein the advertiser engages with an end user in a real-time communication; another in which the advertiser goes live, and also engages with the end user via RTC, but has no dependency on the status of the ephemeral/temporary channel. It should be noted that channels may provide a viewer with real world experiences, virtual world experiences, or augmented reality experiences.

Channel Provider: Person(s) or entity responsible for configuring and managing a channel. As indicated in the channel definition, a channel does not have to be associated with an advertisement.

Advertisement Components:

Ad server: Serves both static and live teaser advertisements to a publisher for display to end users.

Ad database: Stores both static and live teaser advertisements that may be pulled by an ad server.

LivingAd(s) or Living Ad(s): Online advertisements presented with real-time content and communications features. The LivingAds advertisement is comprised of two components: “teasers”, or “teaser ads”, residing on the publisher, and content details, residing on its associated channel. In some cases, RTC can be achieved directly in the live teaser itself without the Ad Viewer (End User) having to select the teaser ad. Self-contained static teaser ads, with RTC features dormant, can convert to live teaser ads, with RTC capabilities activated, when their associated channel goes live. Teasers can be served either static or live.

Key Parties/Entities/Actors Included in the Invention Description:

Advertiser: Company or person or other entity promoting the advertisement.

Publisher: Web page presenting the teaser advertisements. A publisher may be an external web page, or another internal (within a set network) channel that offers advertisements. A publisher can also be an Advertiser, in which case its channel may not necessarily offer advertisements or other teaser ads.

Ad Viewer/End User—the entity that goes to a published web page, views the teaser, and then clicks on the teaser to “talk to the advertiser” when the teaser is live. The terms “ad viewer” and “end user” are used interchangeably and synonymously throughout this application.

Agency—the entity that hosts the teaser ad HTML, CSS, JavaScript code and any other necessary software, to display the teaser, as well as the entity that makes the teaser available to the Ad Exchange.

LivingAds Server—the entity that hosts the portal for the advertiser to log into and the RTC server that coordinates the signaling of setting up the instant messaging and/or video/audio call between the Ad Viewer and Advertiser. It is, inter alia, a web portal, digital asset server, RTC server, and RTC ad rules engine.

Ad Exchange—the entity that provides the links to teasers based on availability from various agencies.

### BRIEF DESCRIPTION OF SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a schematic view showing a simplified advertising cycle as executed by the inventive system, presented to and experienced by an end user;

FIG. 2 is a schematic overview showing a LivingAds cycle in which an end user selects a live teaser ad displayed on a publisher channel, which triggers the ad presentation to the end user and commences bidirectional real-time communication (“RTC”);

FIG. 3 is a schematic view showing accessibility to a channel limited by a predetermined number of simultaneous end users granted RTC access;

FIG. 4 is a schematic view showing the LivingAds cycle when a channel has reached a maximum number of simultaneous end users with RTC access such that further end users are denied RTC privileges while still allowed access to the channel;

FIG. 5 is a schematic view showing a general overview of a “revolving door” method of regulating end user access to a channel;

FIG. 6 is a schematic view showing a channel with programmed live teaser ads released to publishers when a predetermined maximum number of simultaneous end users with RTC access has not been reached;

FIG. 7 is a schematic view showing the same channel with a set limit on the number of simultaneous end users granted RTC access, with live teasers programmed not to be released to publishers when the predetermined maximum number of simultaneous end users with RTC access has been reached;

FIG. 8 is a schematic view showing a revolving door method and a live teaser ad “roll out” method;

FIG. 9 is a schematic view illustrating a channel with live teasers programmed for release to publishers only if network conditions are sufficiently favorable;

FIG. 10 is a schematic view showing another scheme for a channel with live teasers programmed for release to publishers only if the network conditions are good, wherein the network conditions are poor;

FIG. 11 is a schematic view showing a “telepresence” marketing method;

FIG. 12 is a schematic view showing a “telepresence” method in which an end user remotely controls a mobile robot located at a car dealership advertising automobiles for sale;

FIG. 13 is highly schematic and generalized view of the system architecture of the LivingAds system working with a publisher's in-house advertising server of the present invention;

FIG. 14 is a schematic diagram illustrating the inventive LivingAds system incorporated into a conventional or traditional ad agency model and ecosystem;

FIG. 14A is a schematic diagram illustrating a portion of FIG. 14, showing that a LivingAds self-contained teaser ad method may apply as a universal feature in any embodiment of the present invention;

FIG. 15 is a schematic view illustrating the orientation of FIGS. 15A and 15B in relation to one another;

FIG. 15A is a sequence diagram showing how the end-to-end flow of the sequence for making LivingAds available and delivering the teasers to End Users;

FIG. 15B is a continuation of the sequence diagram of FIG. 15A;

FIG. 16 is is a schematic view illustrating the orientation of FIGS. 16A and 16B in relation to one another;

FIG. 16A is a sequence diagram showing the end-to-end flow of the sequence for initiating, conducting, and terminating a discrete RTC session, and thereafter preparing for a next session;

FIG. 16B is a continuation of the sequence diagram of FIG. 16A;

FIG. 17 is a highly schematic flow diagram showing the architecture of a LivingAds server functioning as an ad server;

FIG. 18 is a schematic view illustrating the orientation of FIGS. 18A and 18B in relation to one another;

FIG. 18A is a sequence diagram of the end-to-end flow implemented under the architecture of FIG. 17;

FIG. 18B is a continuation of the sequence diagram of FIG. 18A;

FIG. 19 is a schematic view illustrating the orientation of FIGS. 15A and 15B in relation to one another;

FIG. 19A is a schematic flow diagram showing RTC components as integrated into the Ad delivery platform;

FIG. 19B is a continuation of the schematic flow diagram of FIG. 19A;

FIG. 20 is a schematic diagram showing an ad gamification method of the RTC system of the present invention;

FIG. 21 is a schematic diagram showing an ad gamification method with telepresence;

FIG. 22 is a schematic flow diagram showing the API/SDK located between the Agency and LivingAds Network;

FIG. 23 is a highly schematic view of an embodiment of an anti-click fraud process employed in the present invention;

FIG. 24 is a schematic flow diagram illustrating the anti-click fraud logic of the anti-click fraud process of FIG. 23;

FIG. 25 is a schematic flow diagram illustrating anti-click fraud detail logic showing the process when a browser has already selected a live teaser;

FIG. 26 is a schematic view showing an advertising cycle executed by the inventive system and including an Ad Viewer Validation feature;

FIG. 27 is the same view showing an additional ad metrics feature;

FIG. 28 is the same view, further including an anti-click fraud feature; and

FIG. 29 is a schematic view showing how a click fraud feature prevents a live teaser from being served when click fraud is detected.

### DETAILED DESCRIPTION OF THE INVENTION

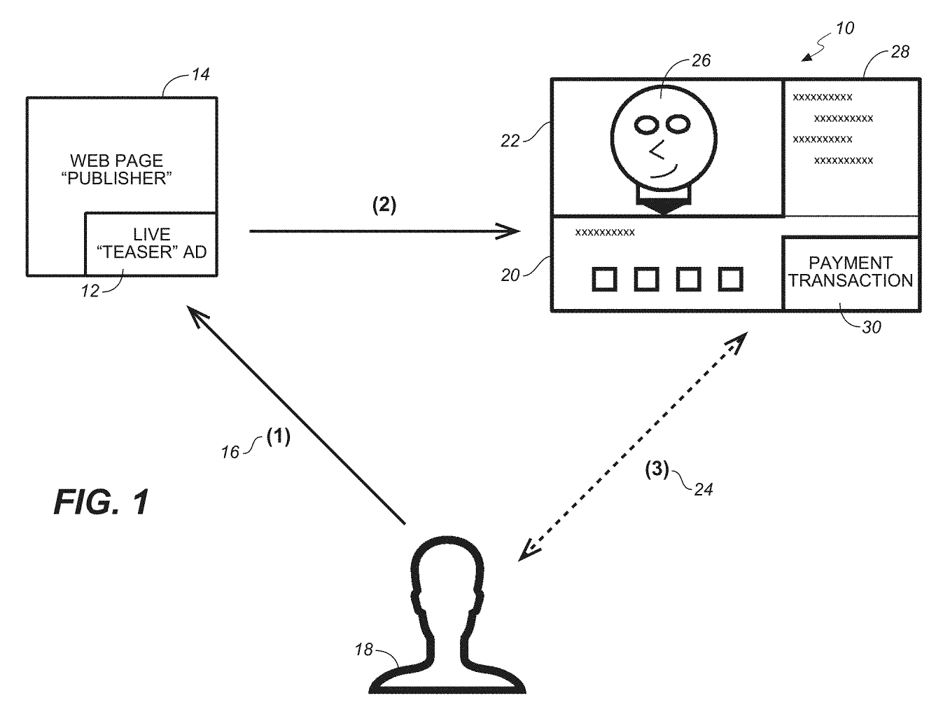

Referring first to FIGS. 1 through 29, wherein like reference numerals refer to like components in the various views, there is illustrated therein a new and improved network-enabled advertising and marketing system and method wherein a live teaser component of a publisher's advertisement is presented with real-time communications features and content, but only when the publisher's associated channel is live, such advertisements are generally referred to herein as “LivingAds.”

FIG. 1 illustrates an embodiment 10 of the inventive system and method, wherein the LivingAds life cycle includes the following six events: (1) First a live teaser ad 12 is displayed, and this is presented on a publisher's website 14. (2) Second, a click-thru is triggered 16; that is, a live teaser ad is selected by the end user 18. (3) Third, content 20 is presented to the end user 18 on the ad's associated channel 22. This is the LivingAds experience. (4) Fourth, there is interaction 24 involving Real-Time Communications (RTC) between the advertiser 26 and the end user 18. (5) Fifth, a confirmation may take place, involving an agreement 28 being reached between the advertiser and the end user (which will naturally vary according to an advertiser's objectives). (6) Sixth, there is a payment transaction 30, wherein money is exchanged between the advertiser 26 and the end user 18. FIG. 1 shows the most general overview of a LivingAds life cycle. The end user 18 selects a live teaser ad 12 displayed on the publisher (web page) 14, which triggers the teaser ad's associated channel 22 to be presented to the end user. The end user and the channel thereafter interact in real-time until the cycle is completed. It is worth noting that the live teaser ad can be served static, then converted to live when its associated channel goes live. Teasers being served both static and live are covered in the following drawings and descriptions.

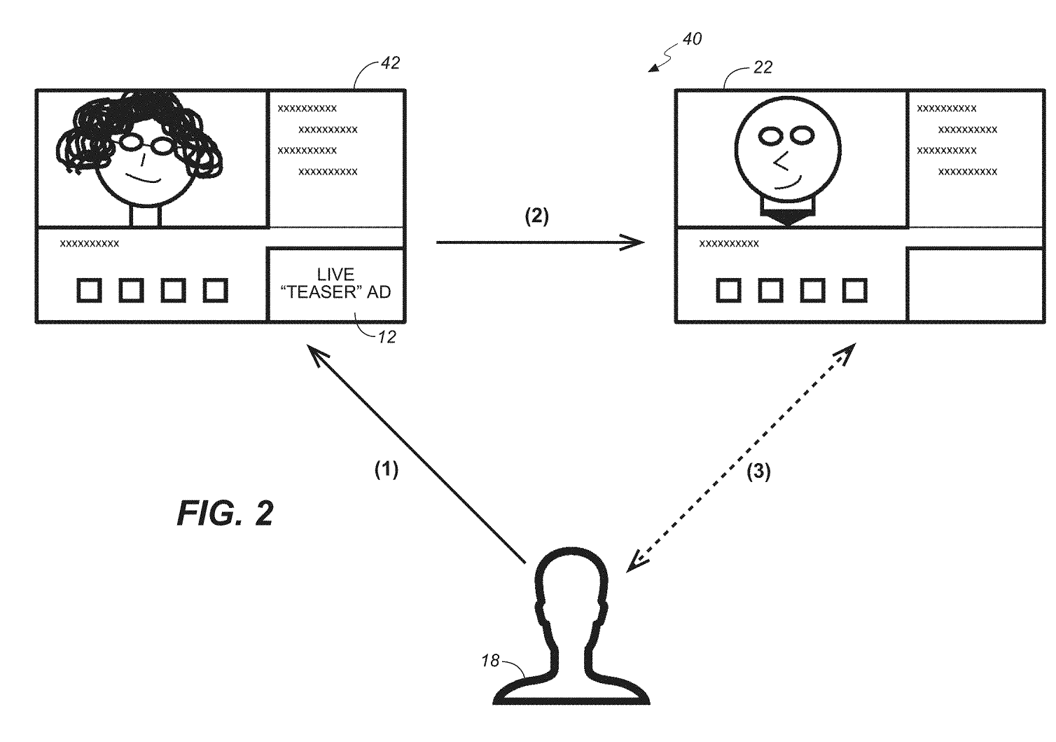

Next, referring to FIG. 2, there is shown a general overview of another embodiment of a LivingAds life cycle 40, wherein an end user 18 selects a live teaser ad 12 displayed on the publisher (channel) 42 to trigger the teaser ad's associated channel 22 to be presented to the end user 18. The end user and the channel are now interacting in real-time.

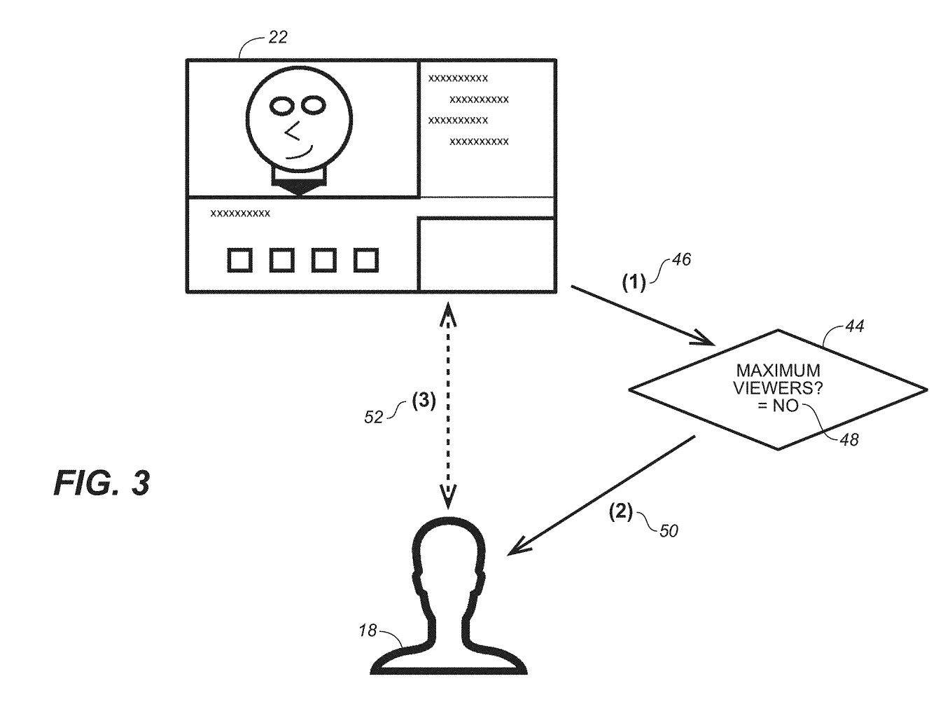

Referring next to FIG. 3, it is seen that a channel 22 has set a limit on the number of simultaneous end users granted RTC access 44. In this drawing, the number of current end users on the channel 22 with RTC privileges is checked 46 and determined that the maximum number has not been reached 48. The end user 18 is thus given immediate access 50 to the channel with RTC privileges and bidirectional communications 52 are initiated.

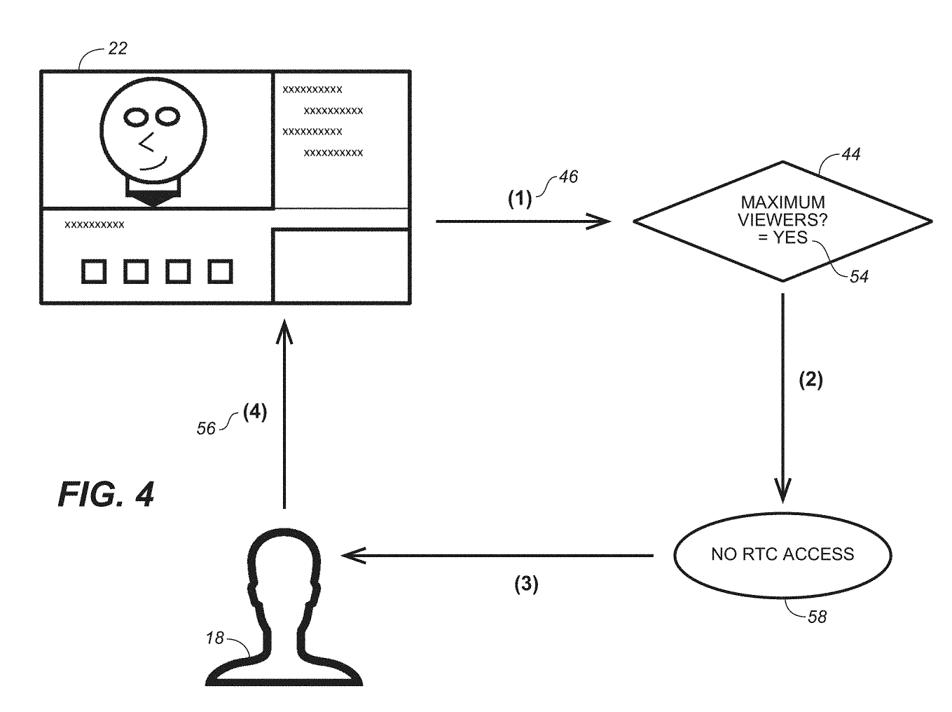

FIG. 4 illustrates a channel 22 viewed by a user 18 but which has reached a maximum number of simultaneous end users with RTC access using the decision rules for limiting RTC access 44. The number of current end users on the channel 22 with RTC privileges is checked 46 and it is determined that the maximum number has been reached 54. The end user 18 is given immediate unidirectional access 56 to the channel 22, but without RTC privileges 58.

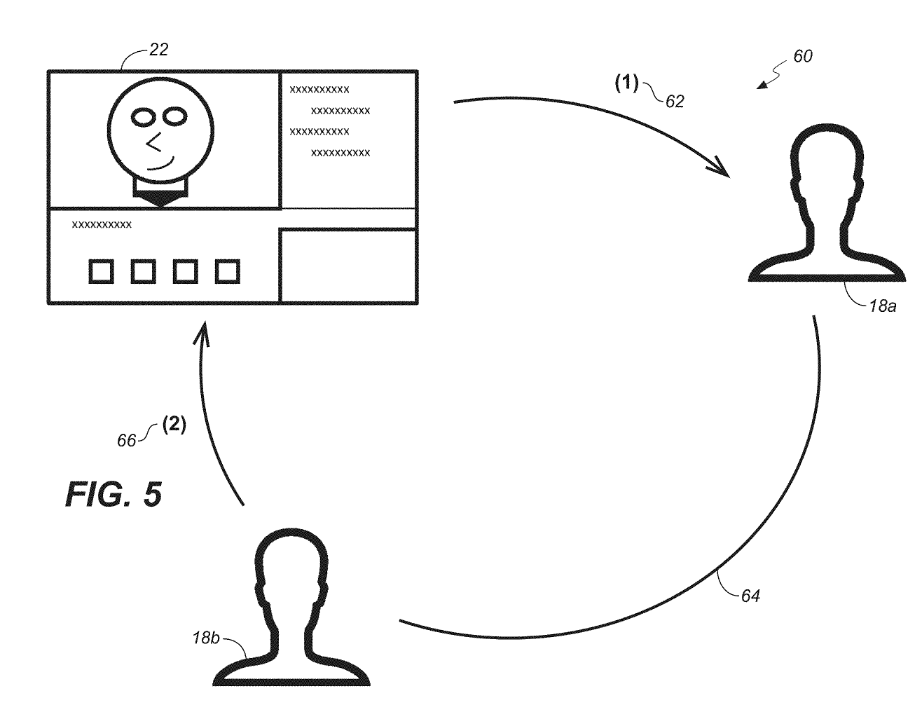

FIG. 5 provides a general overview of a “revolving door” method 60, wherein as one end user granted RTC privileges exits the LivingAds cycle, another end user is granted RTC access: one out, one in. In this drawing, one end user 18a granted RTC privileges 62 exits the channel 22, immediately leaving an opening 64 for another end user 18b to enter the channel with RTC privileges 66.

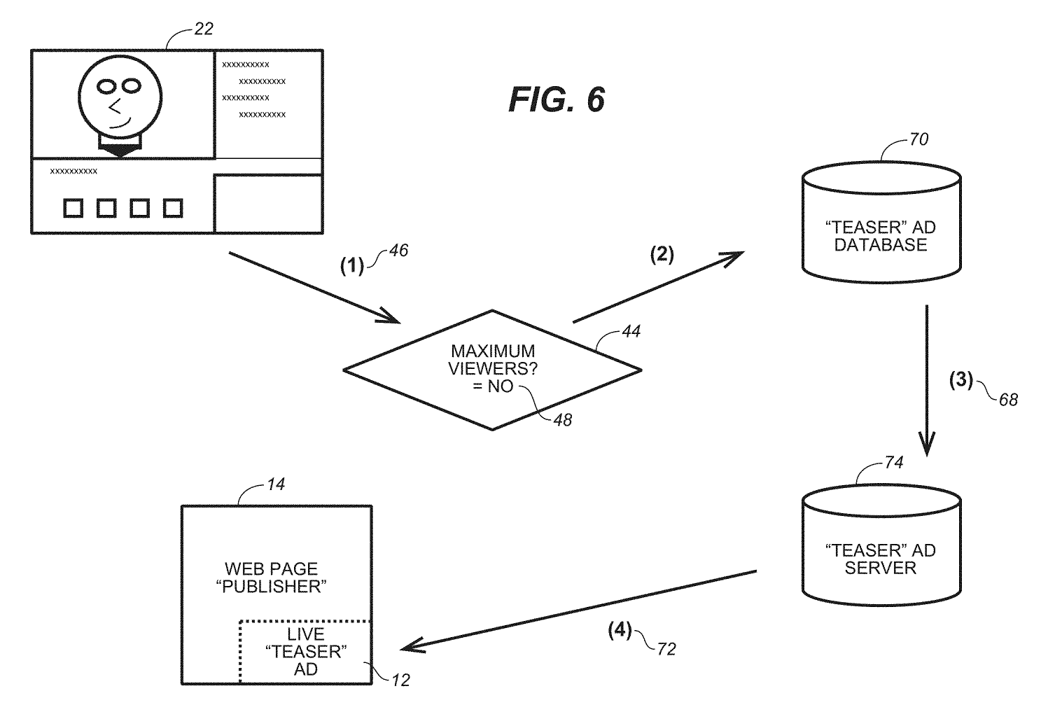

FIG. 6 shows how a channel 22 participating in a LivingAds campaign may have set a limit 44 on the number of simultaneous end users granted RTC access, and has programmed their live teaser ads 12 to be released (“rolled out”) to publishers 14 only if the maximum number of simultaneous end users with RTC access has not been reached. In this drawing, the number of current end users on the channel 22 with RTC privileges is checked 46 and determined that the maximum number has not been reached 48. The channel's associated live teaser ad is pulled 68 from the teaser ad database 70 and served 72 to the publisher 14 from the teaser ad server 74.

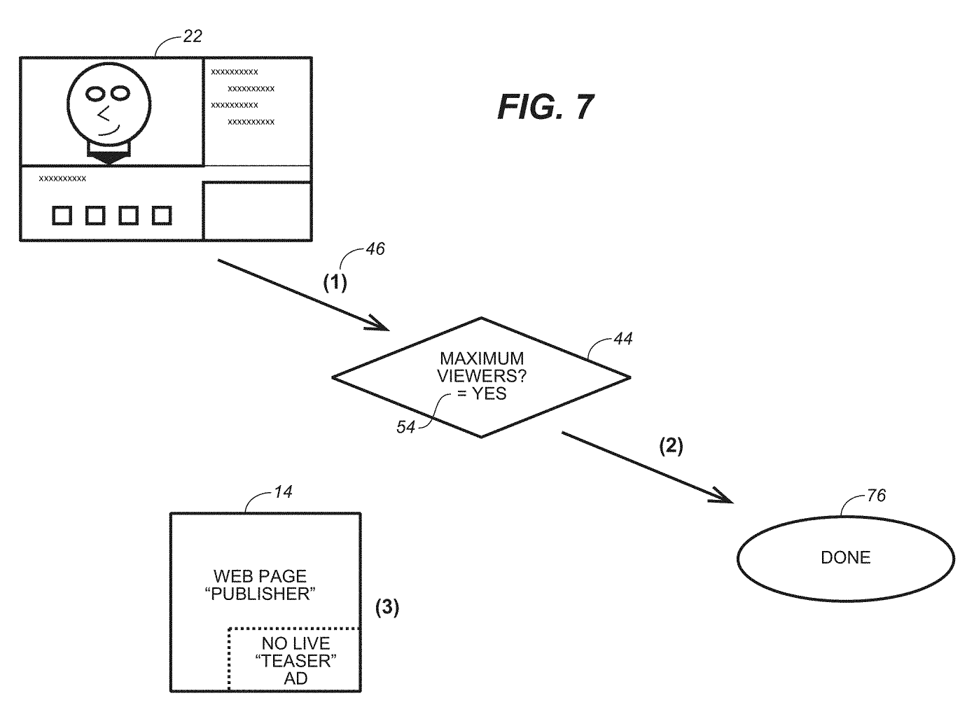

FIG. 7 shows a channel 22 participating in a LivingAds campaign, which has set a limit 44 on the number of simultaneous end users granted RTC access, and has programmed live teaser ads to be released (“rolled out”) to publishers 14 only if the maximum number of simultaneous end users with RTC access has not been reached. In this drawing, the number of current end users on the channel 22 with RTC privileges is checked 46 and it is determined that the maximum number has in fact been reached 54. This precludes the live teaser ad from being released 76 to the publisher 14. Note: static teaser ads can be served and activated, and thereafter converted to live status when, as in this case, the maximum amount of viewers has not been reached.

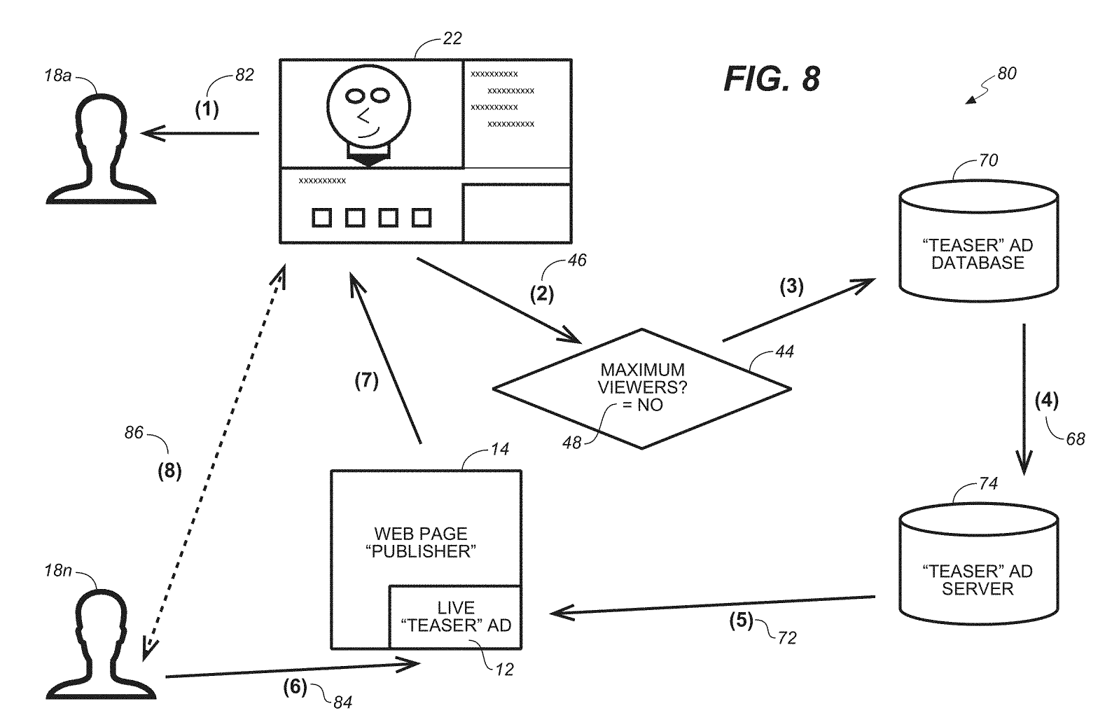

FIG. 8 illustrates a scheme 80 involving both the “revolving door” method and, related, live teaser ad “roll out” to publisher. In this drawing, an end user 18a granted RTC privileges 82 exits the channel. The number of current end users on the channel 22 with RTC privileges is then checked 46 and it is determined that the maximum number has not been reached 48. The channel's associated live teaser ad is pulled 68 from the teaser ad database 70 and served 72 to the publisher 14 from the teaser ad server 74. The end user 18n selects 84 the live teaser ad 12 displayed on the publisher (web page) 14 which triggers the teaser ad's associated channel 22 to be presented to the end user 18n. The end user and the channel are now interacting in real-time 86.

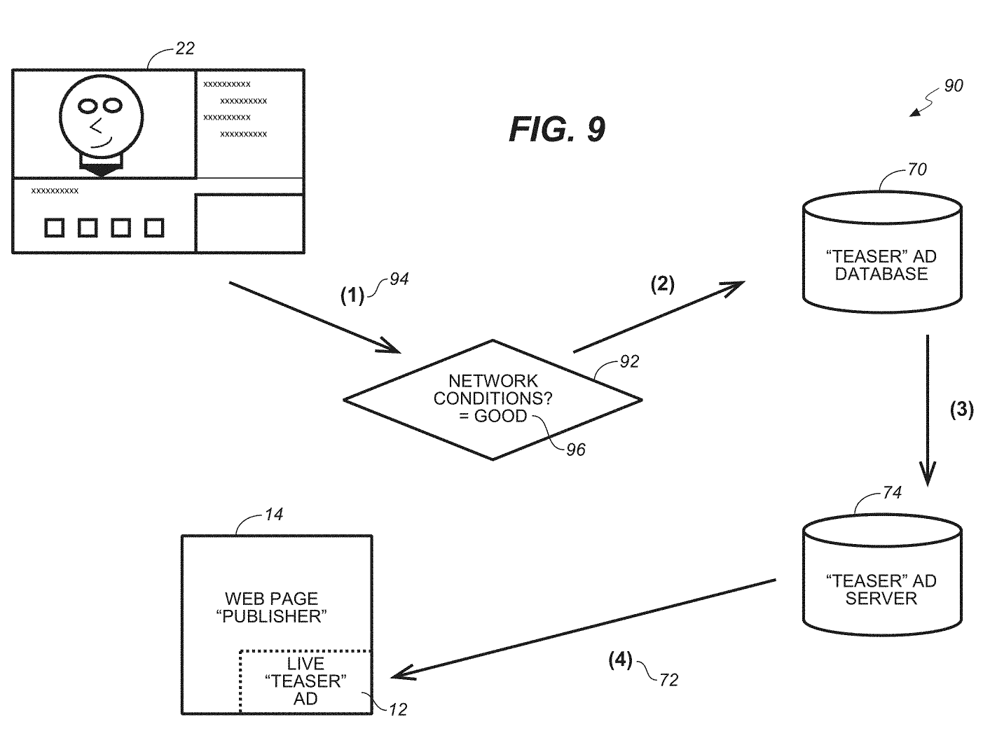

FIG. 9 illustrates an alternative embodiment 90 in which a channel 22 participating in a LivingAds campaign includes a network conditions check 92 and to release (“roll out”) live teaser ads to publishers 14 only if the network conditions are good. In this drawing, a network conditions check is performed 94 and it is determined that the conditions are good 96, so the channel 22 allows additional end users with RTC privileges at this time. The channel's associated live teaser ad 12 is pulled 68 from the teaser ad database 70 and served 72 to the publisher 14 from the teaser ad server 74.

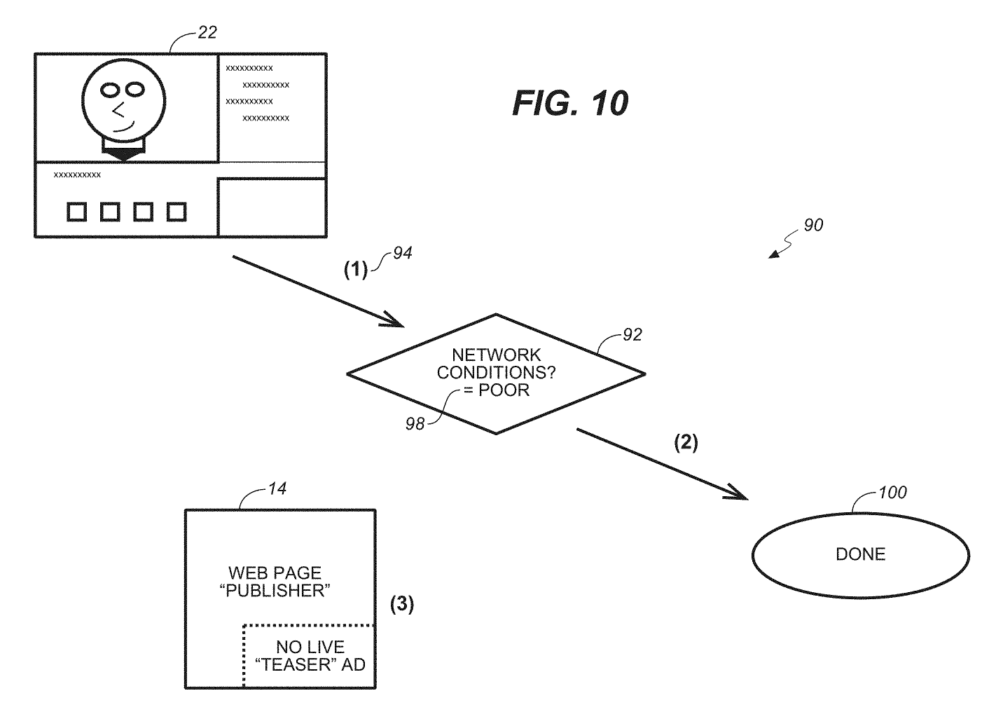

FIG. 10 shows an embodiment 90 having a channel similarly participating in a LivingAds campaign that has programmed live teaser ads released (“rolled out”) to publishers only if the network conditions are good 92. In this drawing, a network conditions check is performed 94 and it is determined that the conditions are poor 98, so the channel 22 does not allow for additional end users with RTC privileges at this time; resulting in no live teaser ad being released 100 to the publisher 14. As indicated above, static teaser ads can be served, activated, and may convert to live status when, as in this case, the network conditions are good.

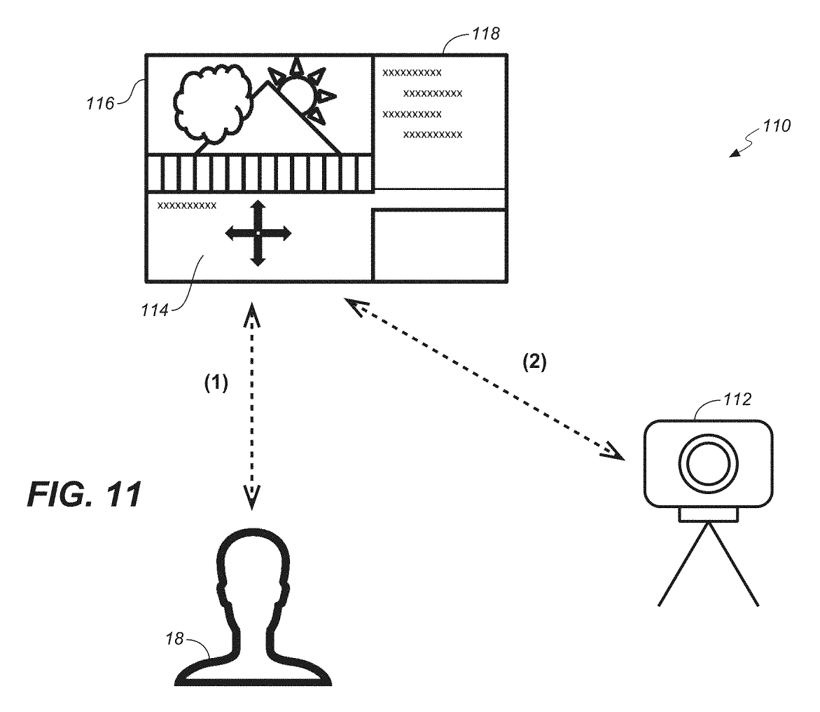

FIG. 11 is a schematic overview 110 of a “telepresence” method. In this drawing, an end user 18 remotely controls a camera 112 with PTZ (Pan, Tilt, Zoom) functionality, with navigation controls 114 provided through the web page 118 of an establishment—e.g., a bed & breakfast—featuring its mountain view 116 on the channel or web page 118. The end user utilizes the navigation controls offered on the channel which, in turn, sends commands 119 in real-time to the camera. The end user is able to experience this view from the B&B as if he/she were actually physically present. This is an especially effective marketing method.

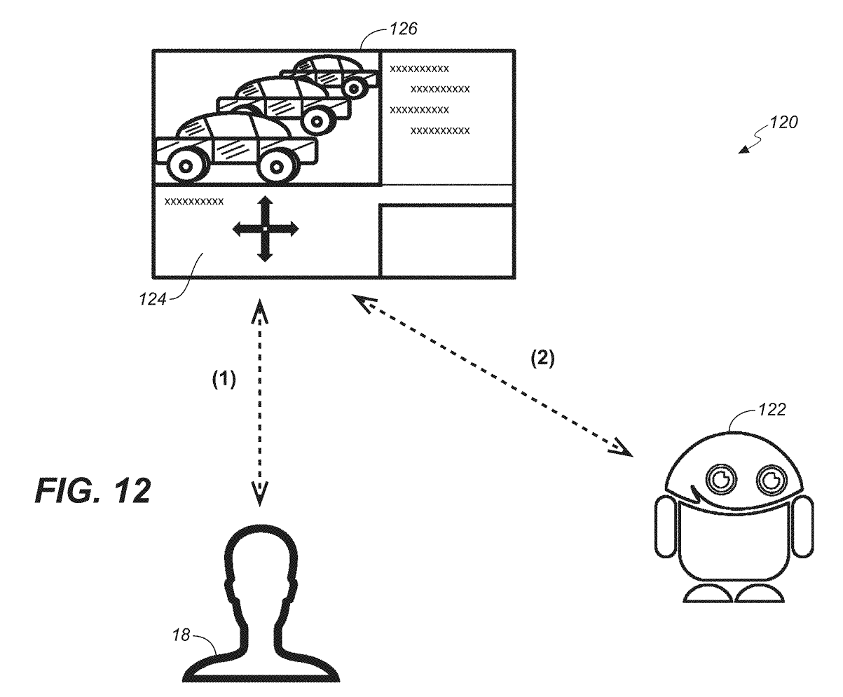

Finally, FIG. 12 provides a general overview of another “telepresence” method 120. In this drawing, an end user 18 is remotely controlling a mobile robot 122, located at a car dealership advertising automobiles now for sale. The end user utilizes the navigation controls 124 offered on the channel 126 which, in turn, sends commands 128, in real-time, to the robot. The end user is able to experience the car dealership as if he/she were actually physically present at the dealership. This, too, is a highly effective marketing method.

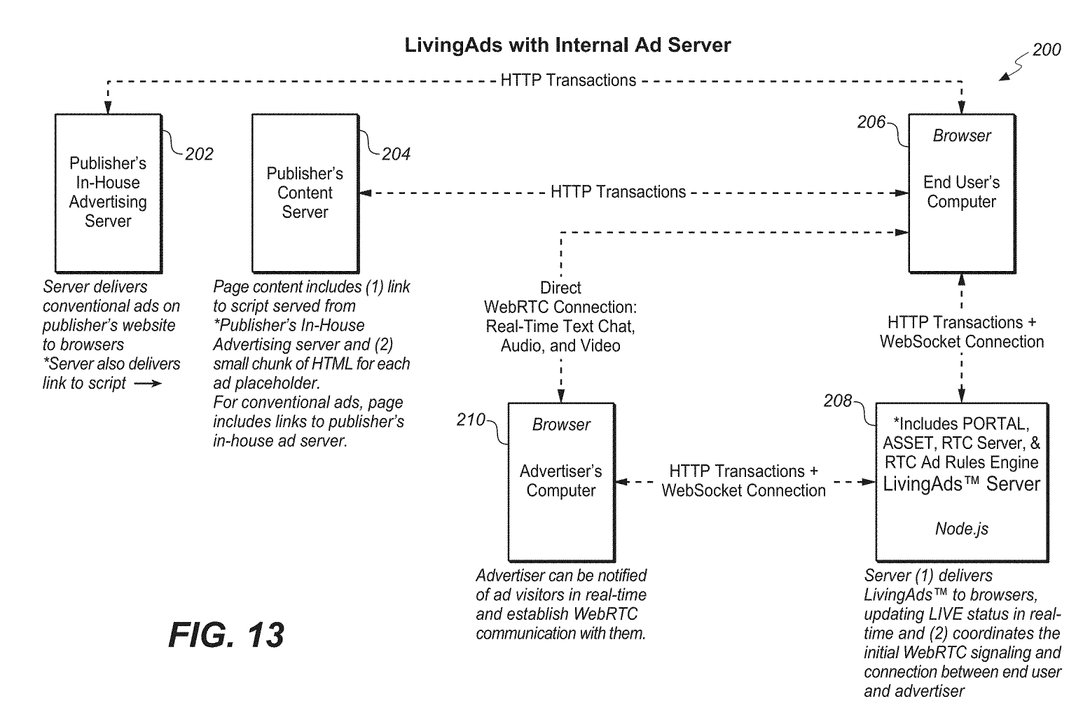

FIG. 13 is highly schematic and generalized view of the system architecture 200 of the LivingAds system of the present invention working with a publisher's internal ad server. In this view it is seen that system architecture includes a Publisher's in-house advertising server 202, which delivers conventional ads on the Publisher's website to browsers. It also delivers a link to script presented in conjunction with webpage content included on the Publisher's content server 204. Other content on the Publisher's content server include a small chunk of HTML for each ad placeholder. The page may include links to the Publisher's in-house server 202 for conventional ads. An End User's network connected device 206 will include web browser or other application for retrieving information from the worldwide web and for presenting it to the End User. When the End User opens the webpage on the Publisher's content server 204 (typically via a URL), if the Publisher's internal server provides a page that includes any LivingAd teasers, the internal Publisher's in-house ad server sends a script, initially provided by LivingAds through the LivingAds server 208. Alternatively, the script can be sent from an external LivingAds server. This opens a WebSocket connection (for that browser tab) to the LivingAds server 208. Through the open WebSocket, the script sends the LivingAds server the identification of all the teasers on the Publisher's content server page. The LivingAds server can also send LIVE features to be placed on top of any existing static teaser ads, including a “LIVE” button, which, when selected, activates the now live teaser's real-time communications capabilities. When the Advertiser goes LIVE on its channel, its associated teaser ad(s) are enabled into the system. The Advertiser then becomes available to participate in a RTC session with the End User via its network connected computer 210. The Advertiser then becomes a “live” participant in a RTC session with the End User.

Summarily stated, when a publisher's internal server serves a page that includes any LivingAd teasers, it sends a script (provided by LivingAds) that opens a WebSocket connection (for that browser tab) to the LivingAds server. Through the open WebSocket, the script sends the LivingAds server the identification of all the teasers on the page. When an advertiser goes live on its channel, the LivingAds server sends that info back to the script in the browser, which replaces the static teaser with a live teaser. As an alternative, the LivingAds server can send LIVE feature(s) to be placed on top of the existing static teaser ad, such as a “LIVE” button which, when selected, activates the now live teaser ad's real-time communications capabilities.

It should be noted that the inventive LivingAds system must integrate two detailed and interconnected data flows. The RTC experience requires persistent connections (typically persistent HTTP transactions) for WebRTC media negotiations to take place between an End User and an Advertiser to share a two-way call. The online display advertising process links End Users, and potentially End User profiles, with Advertisers, Advertising Agencies, and Ad Exchanges to connect Publishers and Advertisers.

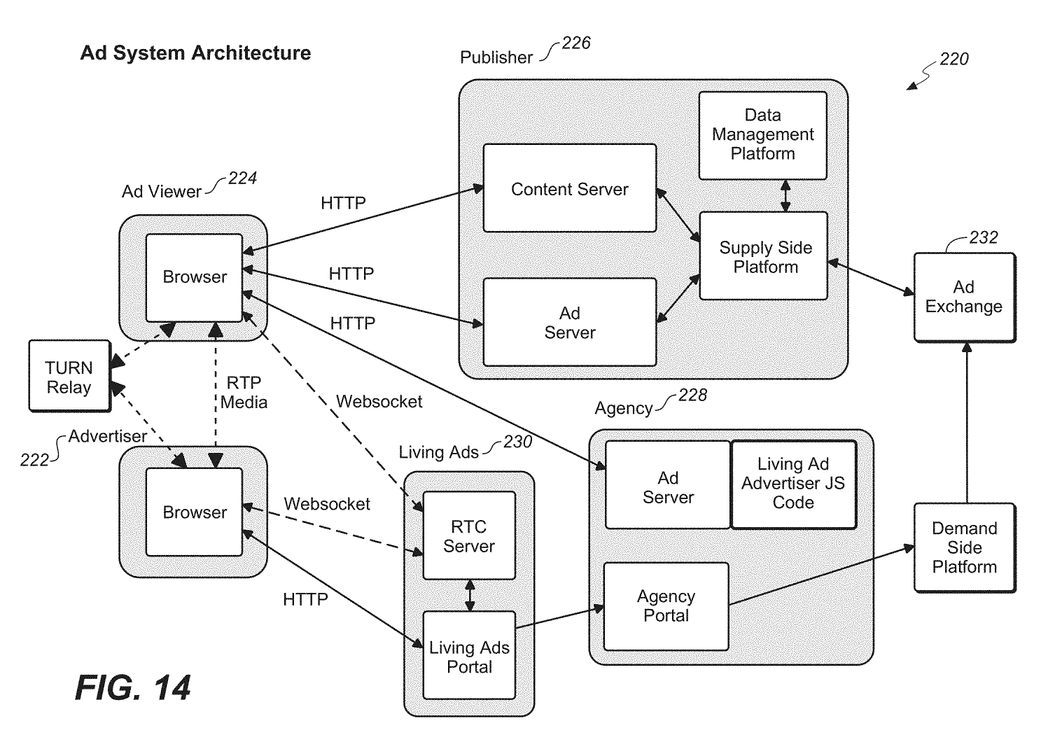

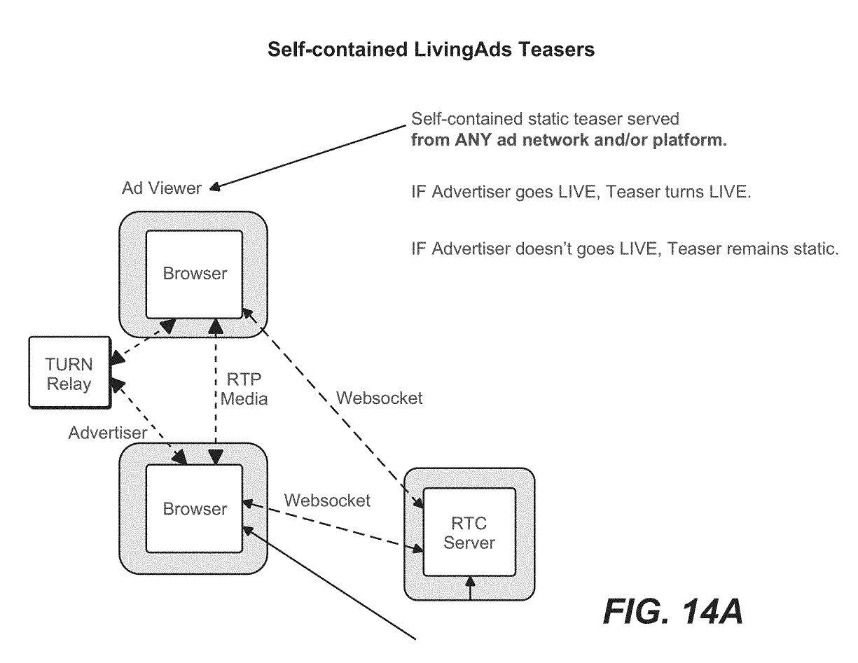

FIG. 14 shows that the LivingAds system architecture 220 comprises six principle components, including: (1) the Advertiser 222, which is the entity (either a company or a natural person) that enables teasers into the system via its Advertiser browser; (2) the Ad Viewer/End User 224, which is the person that goes to a published web page, sees the teaser from the Advertiser, and then selects the live teaser to “talk to the advertiser”; (3) the Publisher 226, which is the entity that publishes the content the Ad Viewer (End User) views and finds the teaser, likely content that is aligned with the interests of the Ad Viewer and the Advertiser's products (a Publisher is present in the system as a web page presenting the teaser advertisements, either as an external webpage, or another internal—within a set network—channel that offers advertisements); (4) the Agency 228, which is the entity that hosts the teaser HTML, CSS, JavaScript code, and any other necessary software to display the teaser, as well as the entity that makes the teaser available to the Ad Exchange; (5) the LivingAds Server 230, which is the entity that hosts the portal for the advertiser to log into and the RTC server that coordinates the signaling of setting up the instant messaging and/or video/audio call between the Ad Viewer and Advertiser. It is, inter alia, a web portal, digital asset server, RTC server, and RTC ad rules engine; and (6) the Ad Exchange 232, which is the entity that provides the links to teasers based on availability from various agencies.

FIG. 14A is a schematic diagram illustrating a portion of FIG. 14, showing that a self-contained static teaser ad can be served from any ad network and/or platform, even when an advertiser is not live. A static teaser may be served to the end user's browser. An HTML <iframe> tag is an example of a self-contained independent unit that can be applied to this embodiment. The LivingAds script run by the iframe opens a WebSocket to the LivingAds server and identifies itself so that the LivingAds server can send updates regarding the advertiser's availability status, and later establish peer-to-peer WebRTC connections between the user's browser and the advertiser.

This self-contained teaser has embedded script that enables the teaser to change from static-to-live; an event which takes place only if the teaser's associated advertiser goes live on its channel. The same RTC logic and functionality previously discussed in this document applies to this embodiment. It should be noted that the live teaser changes back to its default, static, state when the advertiser is not live.

Salient features and differences in this embodiment include: (1) the initial step of the teaser being served does not involve the advertiser going live on its channel; in other words, the advertiser going live on its channel doesn't trigger the live teaser being served as with some of the other embodiments mentioned in this document; and (2) the teaser, by default, is static and only converts to a LIVE teaser ad when its associated advertiser goes live on its channel. However, this self-contained static teaser method can be applied to all the embodiments mentioned in this document.

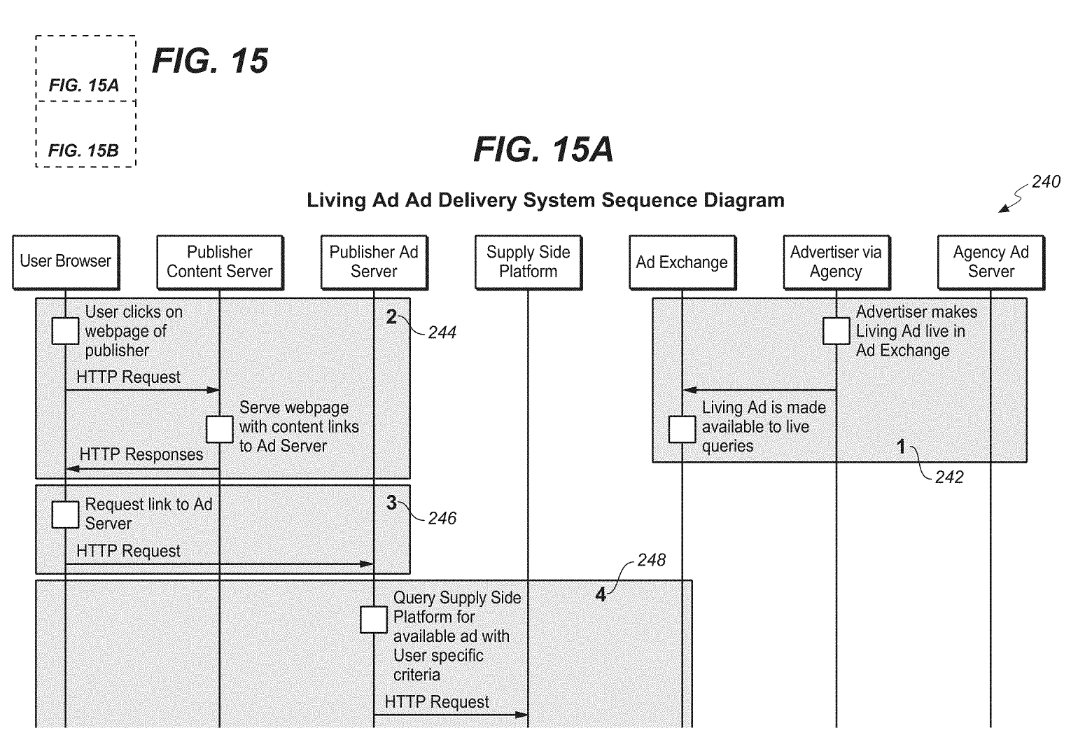

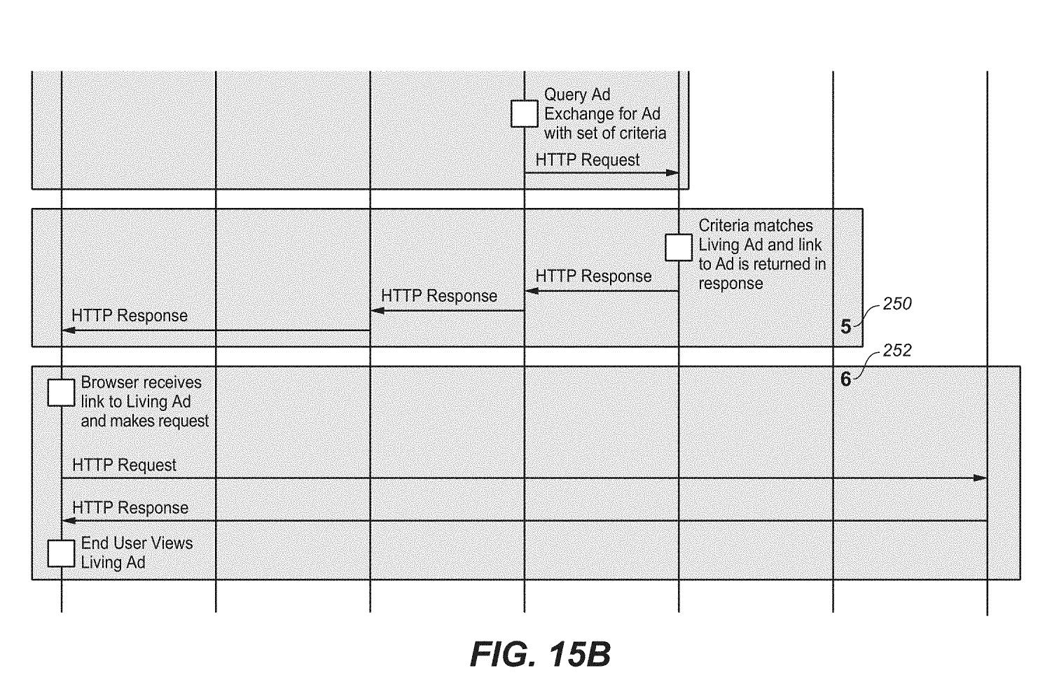

Referring next to FIG. 15, there is shown a sequence diagram 240 of an end-to-end flow of the sequence for making LivingAds available and for delivering the teaser ads to End Users. The flow includes the steps of an Advertiser providing HTML, CSS, and JavaScript code, and any other necessary software to the Agency 242. Once the Advertiser is ready to go live on its channel, the Agency puts the teaser into the Ad Exchange for pickup by publishers.

Next, the Ad Viewer in parallel clicks on a link to the publisher web page and downloads the publisher content, including links to the Ad Server 244.

Next, the Ad Viewer browser then uses those links to query the Ad Server for advertisements to render inside the publisher page 246.

Then the Ad server may have some details about the user it may use to customize Ads for the Ad Viewer and makes a request to the Supply Side Platform that can query one or more Ad Exchanges 248.

Then, because the LivingAd teaser was enabled in the Ad Exchange it can be chosen as the ad to deliver to the user. A link to the teaser ad's Agency webserver is provided back to the Ad Viewer 250.

Finally, the Ad Viewer's browser uses the URL provided to request the teaser from the Agency webserver and renders the LivingAd for the Ad Viewer 252.

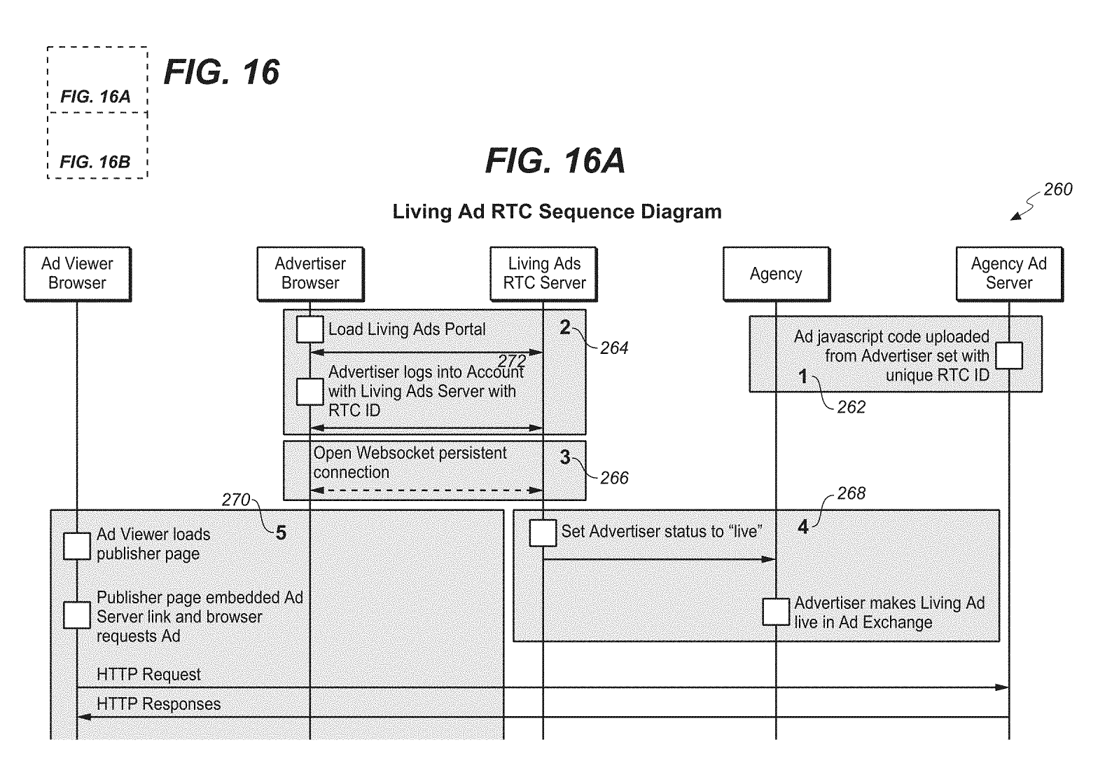

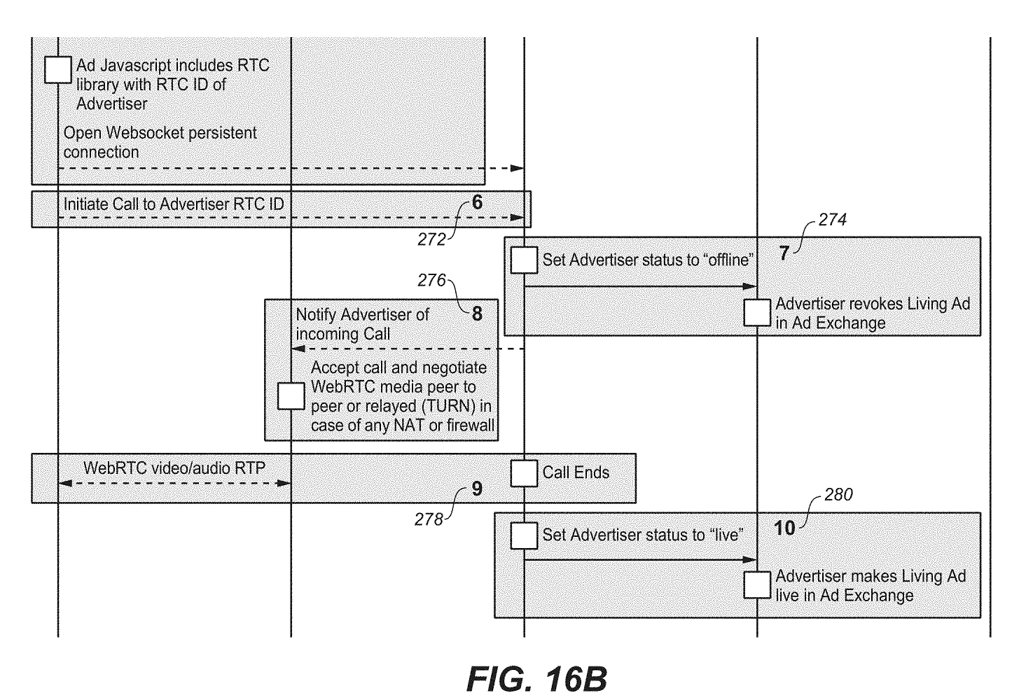

FIG. 16 is a sequence diagram showing the end-to-end flow of the sequence for initiating, conducting, and terminating a discrete RTC session, and thereafter preparing for a next session. The sequence diagram of FIG. 16 shows an Advertiser triggering live teasers to be displayed. The sequence diagram describes the usage of WebSocket connections as the RTC signaling channel. Optionally a HTTP/2 based signaling channel could be established in a similar way.

Referring now to FIG. 16, it will be seen that the teaser Advertisement JavaScript code will embed a unique RTC ID to identify to the RTC server to which advertiser it should route incoming call notifications 262. Once the Advertiser is ready to go live on its channel, it logs into the LivingAds Portal and sets its status to LIVE 264. This session should be associated to the RTC ID set above.

The Advertiser next establishes a persistent signaling channel over WebSockets to the LivingAds RTC Server 266.

Next, the LivingAds RTC server calls an Agency API to set the LivingAd teaser to available in the corresponding Ad Exchanges 268. The Advertiser then waits for an Ad Viewer to select the live teaser to initiate a video/audio (and/or IM) session 270. When an Ad Viewer/End User initiates the call 272, the LivingAds RTC Server sets the status of Advertiser to “offline” to prevent any simultaneous calls 274. Note: An “offline” signal is set only if the maximum number of simultaneous ad viewers is reached; otherwise, the advertiser's status remains as “available/live.”

The Advertiser gets a notification of an incoming call over the WebSocket signaling channel 276. If the Advertiser accepts the call, the WebRTC media negotiation starts using standard WebRTC JSEP style procedures 278, and the video/audio (and/or IM) call takes place, and eventually it ends. The RTC server then sets the Advertiser status to “online” to make him available for the next call 280.

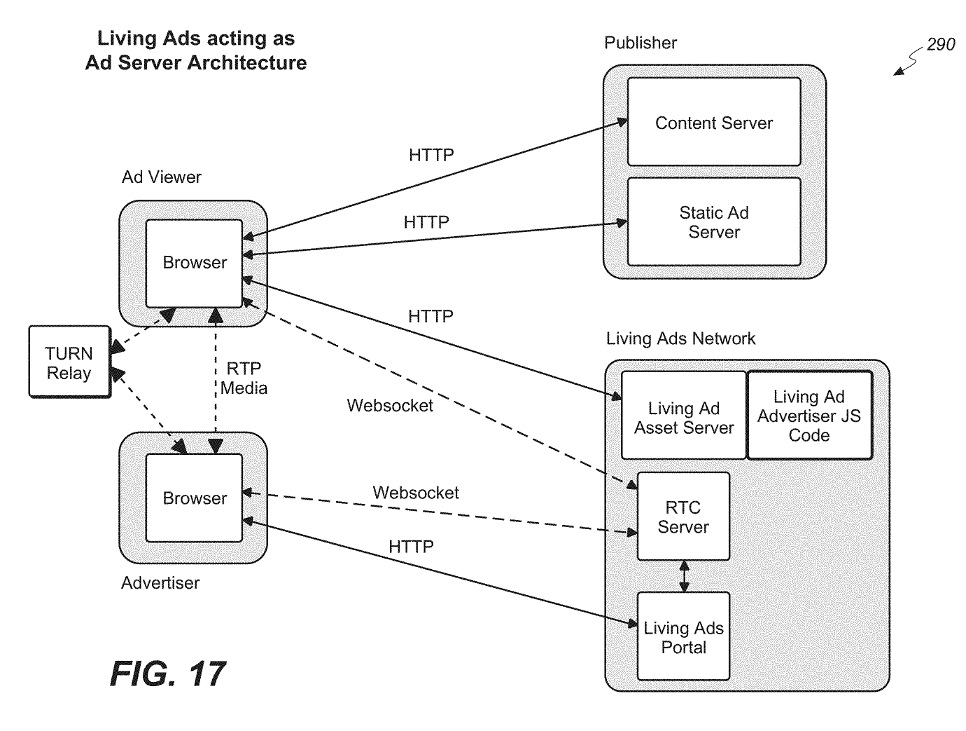

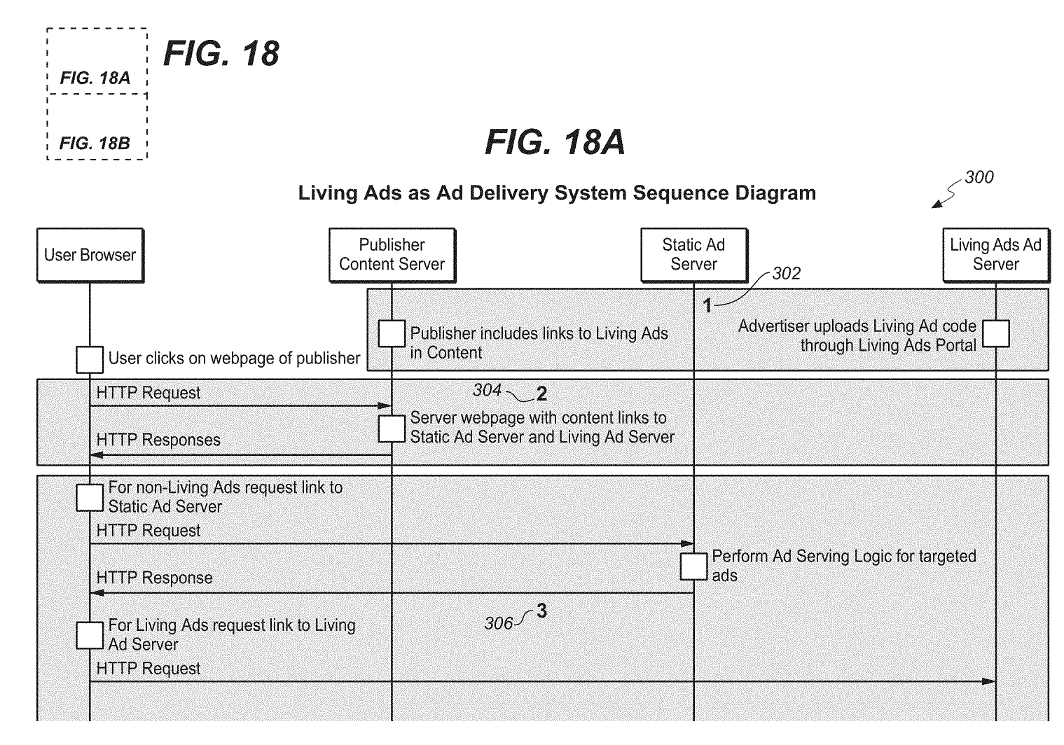

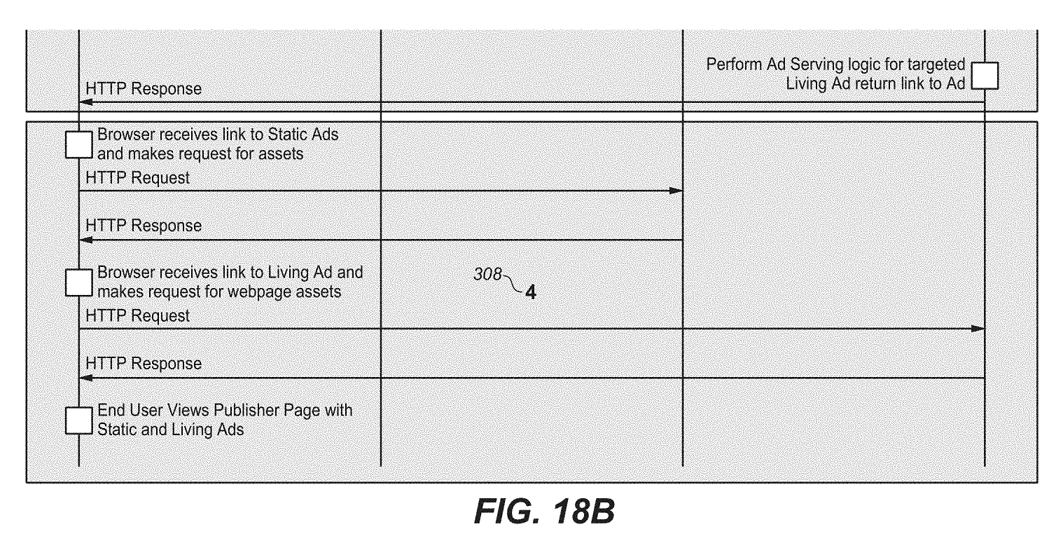

FIG. 17 is a highly schematic flow diagram showing the architecture 290 when a LivingAds server functions as the ad server. FIG. 18 is a sequence diagram of the end-to-end flow 300 implemented under this architecture. Specifically, the Advertiser uploads the HTML, CSS, JavaScript code, and any other necessary software to the LivingAds Ad Server through a portal and receives a link to provide publishers 302. When an Ad Viewer clicks on a link to the publisher web page and downloads the publisher content, including links to both conventional Static Ad Server(s), if applicable, and to the Living Ad Ad Server 304, the Ad Viewer browser then uses those links to query the Static Ad Server(s) and Living Ad Ad Servers for advertisements, perhaps including metadata for ad targeting or otherwise, for rendering inside the publisher page 306. The Ad Viewer's browser then uses the URL provided to request the teaser from the Living Ad. Ad Server and renders the Living Ad teaser to the Ad Viewer 308.

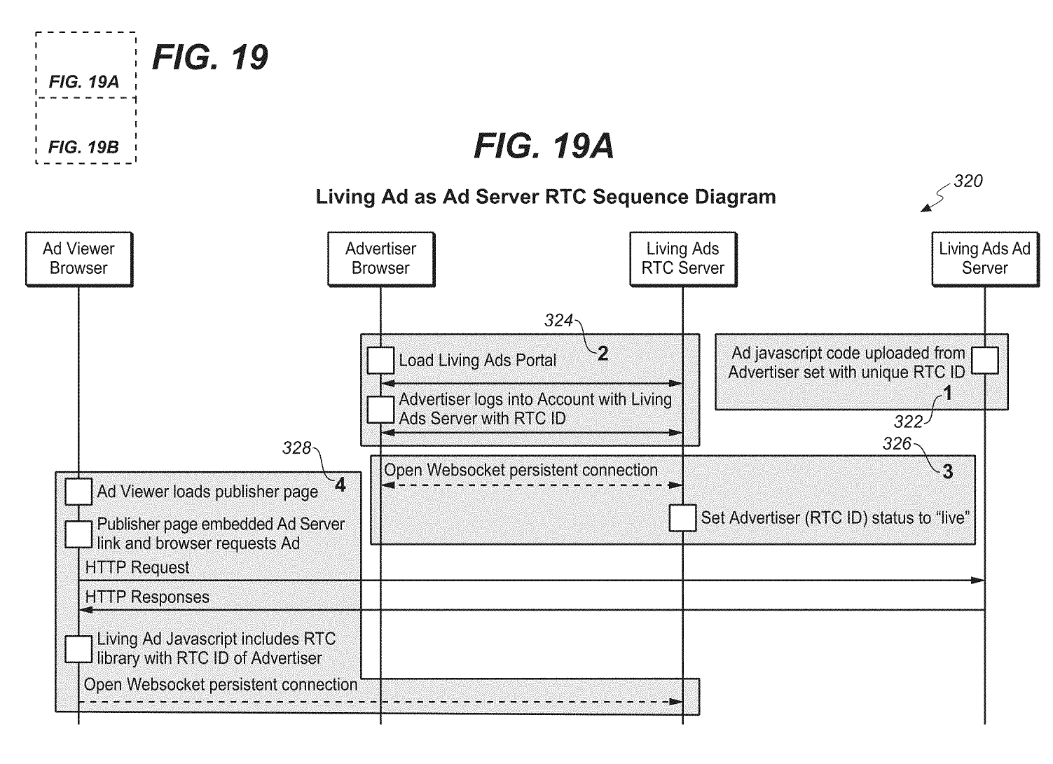

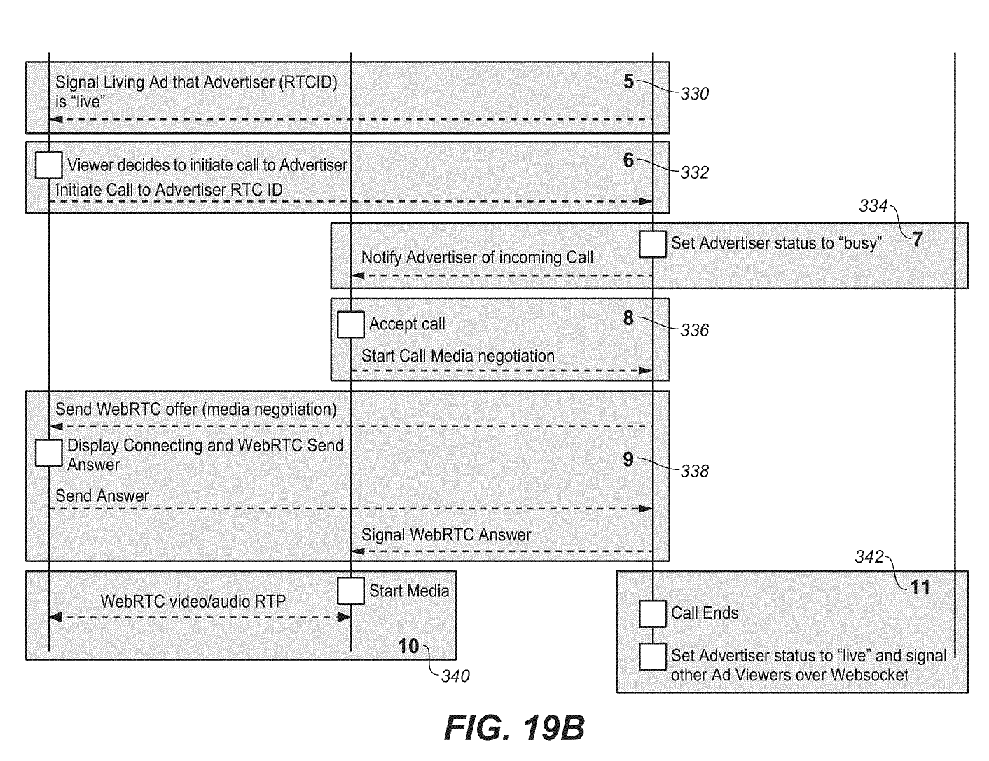

FIG. 19 is a schematic flow diagram 320 showing various contingencies relating to the RTC components and how they integrate into the teaser Ad delivery platform. An Advertiser going live on its channel triggers the availability of the live teasers or optionally displays a status indicator notifying end users that the advertiser is live. As with FIG. 16, the sequence diagram of FIG. 19 shows an Advertiser triggering live teasers and the use of WebSocket connections for the RTC signaling channel.

RTC flow proceeds as follows: First, the teaser advertisement JavaScript code embeds a unique RTC ID to identify to the RTC server to which advertiser it should route incoming call notifications 322. Once the Advertiser is ready to go live on its channel, it logs into the LivingAds Portal and sets its status to live 324. This session may be associated to the RTC ID set above in the LivingAds RTC Server.

Next, the Advertiser establishes a persistent signaling channel over WebSockets to the LivingAds RTC Server, and waits for an Ad Viewer to click on the live teaser to initiate a video/audio (and/or IM) session 326

When an Ad Viewer visits the Publisher and downloads a Living Ad teaser 328, the JavaScript code executes with the Advertiser RTCID and establishes a WebSocket connection to the LivingAds RTC Server. The RTC Server then signals the Ad Viewer Browser that the Advertiser is live and available for a call 330.

Should the Ad Viewer decide to talk to the Advertiser and initiate the call 332, the Ad Viewer browser sends a signaling message to RTC server that the Ad Viewer wants to initiate a call 334. Then the RTC server looks at the RTC ID and corresponding Advertiser, sets Advertiser to “busy” state and signals the Advertiser that there is an incoming call. A “busy” signal is set only if the maximum number of simultaneous ad viewers is reached; otherwise, the advertiser's status remains as “available/live.”

If the Advertiser decides to answer the call, it sends a signaling message to accept the call with WebRTC Media Offer using WebRTC JSEP style procedures 336. The Ad Viewer Browser receives the offer and sends an answer 338. The video/audio (and/or IM) call takes place 340 until it terminates, at which point the RTC server sets the Advertiser status to “live” to make him available for the next call 342. In a broadcast media server environment (one-to-one and/or one-to-many streaming), communications between the Advertiser and the Ad Viewer do not necessarily take place via core peer-to-peer networking. In a broadcast media server environment (one-to-many streaming), media servers, along with other RTC technologies such as DASH (Dynamic Adaptive Streaming over HTTP), HLS (HTTP Live Streaming), and SFU (Selective Forwarding Unit) can be utilized in conjunction with WebRTC or on their own, or even other RTC technologies.

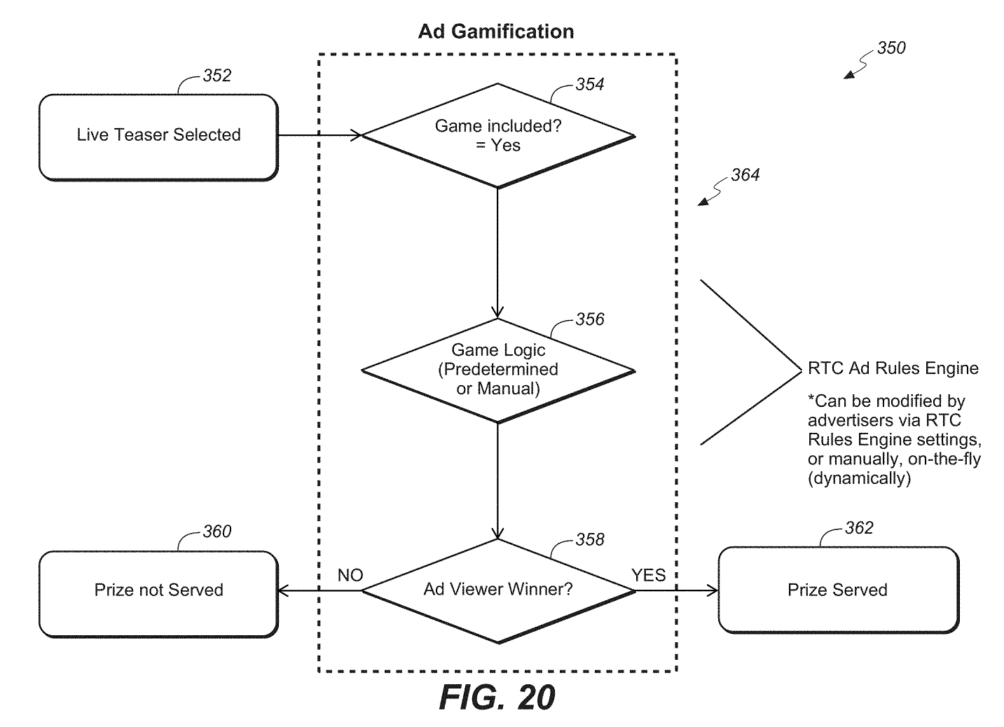

FIG. 20 is a schematic diagram showing an ad gamification method 350 of the RTC system of the present invention. Incentive advertising allows advertisers to reward Ad Viewers for participating in their promotional ads with real-time contests and games. For example, prizes can be presented, in real-time, during an ad gamification “event” based on the ad viewer's action(s). These winning ad viewer actions can be predetermined (via the advertiser's settings and assessed in the RTC Ad Rules Engine) or manual: real-time/dynamic decisions made by the advertiser during the live ad gamification event. FIG. 20 illustrates the process from the live teaser being selected by the ad viewer with a game included for the ad viewer to get a chance at winning a prize. The LivingAd live teaser is selected 352. The system checks to see if there is a game included with the teaser ad 354, as the gamification process is directed principally to live teasers. In the illustrated example there is a game included, so if predetermined game specifications are established 356, the RTC Ad Rules Engine 364 then does its assessment based on the advertiser's settings. An example of automated winnings would include every 100th ad viewer being automatically served a prize. If the Advertiser has settings on “Manual Game specifications”, it can make a decision at any time during the ad gamification event as to whether the ad viewer is a winner. The system, if predetermined, or the Advertiser, if manual, then checks if the Ad Viewer is a winner 358. If the Ad Viewer is not a winner, no prize is served 360. If the Ad Viewer is a winner, a prize is served 362.

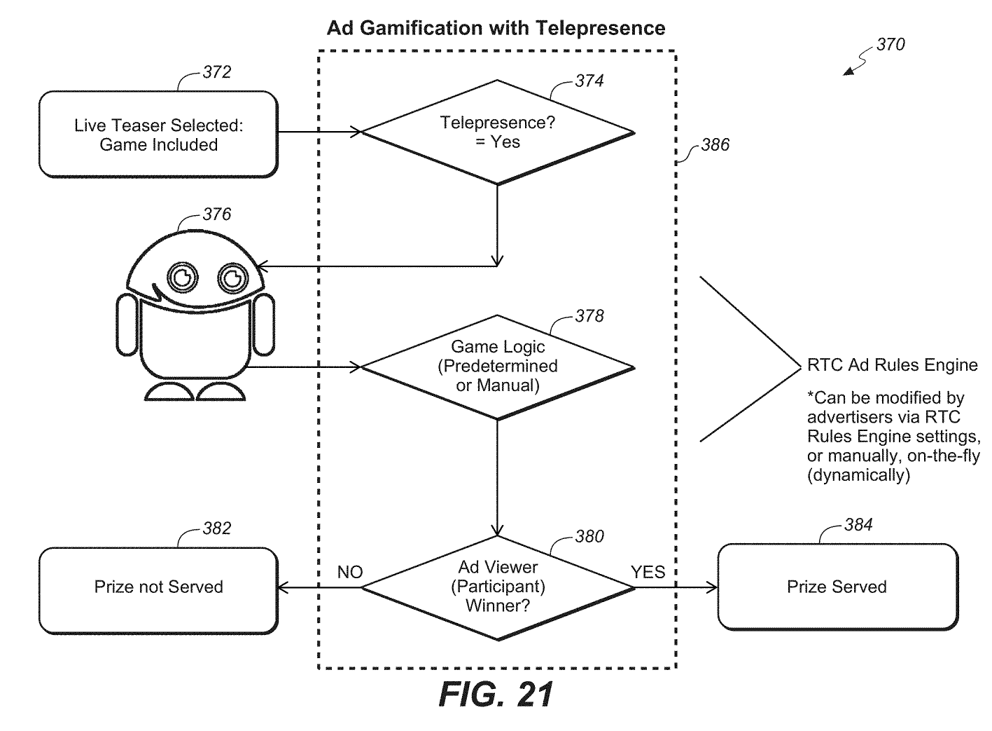

FIG. 21 shows ad gamification with telepresence 370 from the live teaser being selected with a game included 372 for the Ad Viewer to get a chance at winning a prize. In this case, the LivingAd live teaser is served with telepresence capabilities 374. The ad viewer, in this case the Ad Viewer participant, remotely controls a device 376 associated with the teaser ad (in this case a robotic device). If predetermined game specifications are established 378, the RTC Ad Rules Engine 386 then does its assessment based on the advertiser's settings. An example of automated winnings, with telepresence, would include the Ad Viewer participant receiving a prize for driving a robotic device to a specified, or fixed, location in order to win a prize. If the advertiser has their settings on “Manual Game specifications”, they can make their decision at any time during the ad gamification event as to whether the ad viewer participant is a winner. The system, if predetermined, or advertiser, if manual, then checks if the ad viewer participant is a winner 380. If he/she is not a winner, no prize is served 382. If he/she is a winner, a prize is served 384.

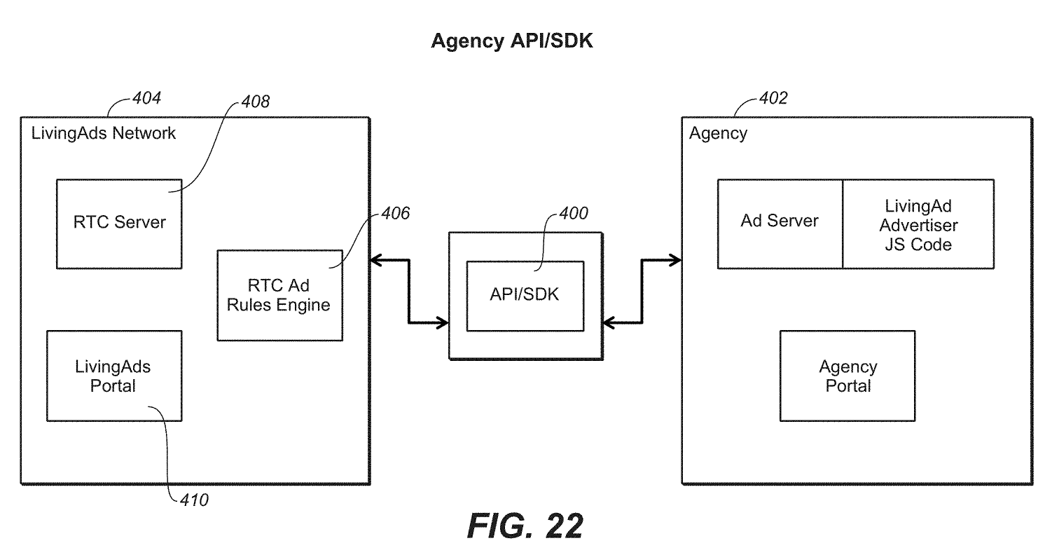

Referring next to FIG. 22, there is shown the API/SDK 400 located between the Agency 402 and LivingAds Network 404. The Agency API(s) and/or SDK(s) is/are included in order for third party advertising agencies to properly interact with the LivingAds System. The RTC Ad Rules Engine 406 plays a critical role here in that this is where the Advertiser's settings are established that ultimately govern the way the LivingAd teaser is served. In this drawing, the Advertising Agency 402 is interacting with the LivingAds Network 404 (which includes the RTC Ad Rules Engine 406, the RTC Server 408, and the LivingAds Portal 410), via the API/SDK 400.

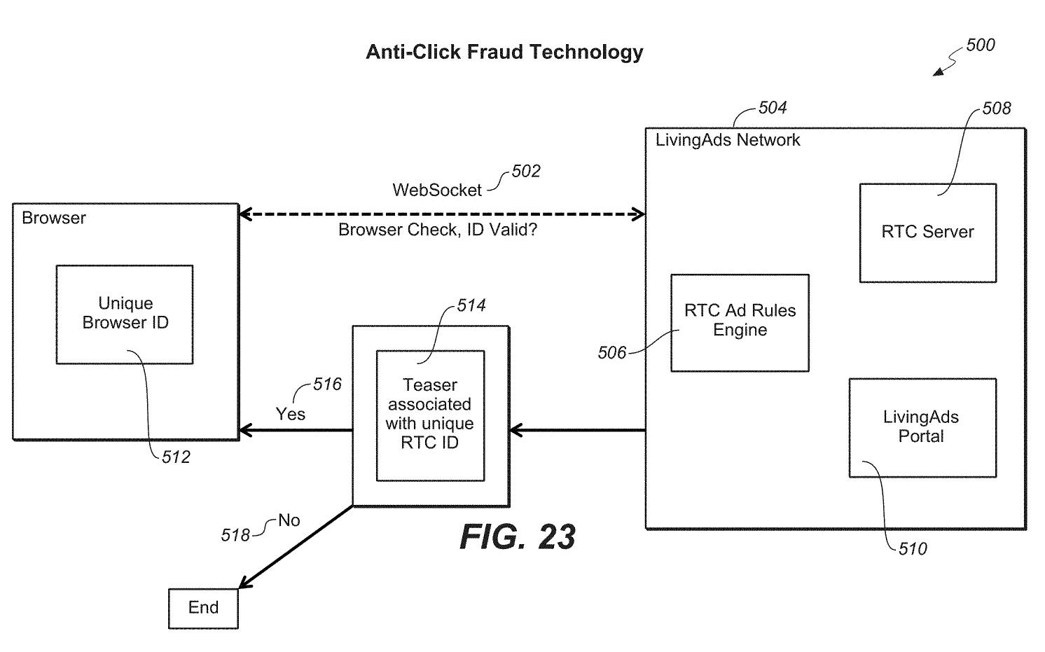

Referring next to FIGS. 23-25, in the inventive system, the Ad Viewer's browser has a unique ID associated with it, and this unique ID can be recognized by the LivingAds system. There are various methods that can be used in obtaining a browser's unique ID, including the use of cookies and other web tracking technologies, as well as client, or device-specific IDs, statistical IDs, universal login tracking, and the like; and all can be utilized with this invention. Mobile user profile data may also be derived from telecom/mobile network operators. For websites and apps that require a login, the RTC system can recognize end users based on login credentials and over all user profiles per their individual settings. Each advertiser is assigned a unique ID during the LivingAds.com registration process, and that “RTC ID” is directly associated with its teaser served. The Anti-Click Fraud method involves comparing the unique browser ID with the advertiser's RTC ID to help prevent click fraud. Furthermore, these browser validation checks are performed in real-time and on an ongoing, consistent basis via the persistent WebSocket connection established between the browser and LivingAds server. This Anti-Click Fraud method makes it possible for advertisers to carefully manage their LivingAds.

The RTC flow for the anti-click fraud method employed in the present invention proceeds as follows: First, the teaser Advertisement JavaScript code embeds a unique RTC ID to identify to the RTC server to which Advertiser it should route incoming call notifications. Once the Advertiser is ready to go live on its channel, he should log into the LivingAds Portal and set his status to live. This session should be associated to the RTC ID set above. FIG. 23 is a highly abstract schematic view of an Anti-Click Fraud process 500. A browser validation check is done via the persistent WebSocket connection 502 between the LivingAds Network 504 (which includes the RTC Ad Rules Engine 506, RTC Server 508, and Portal 510) and unique browser 512.

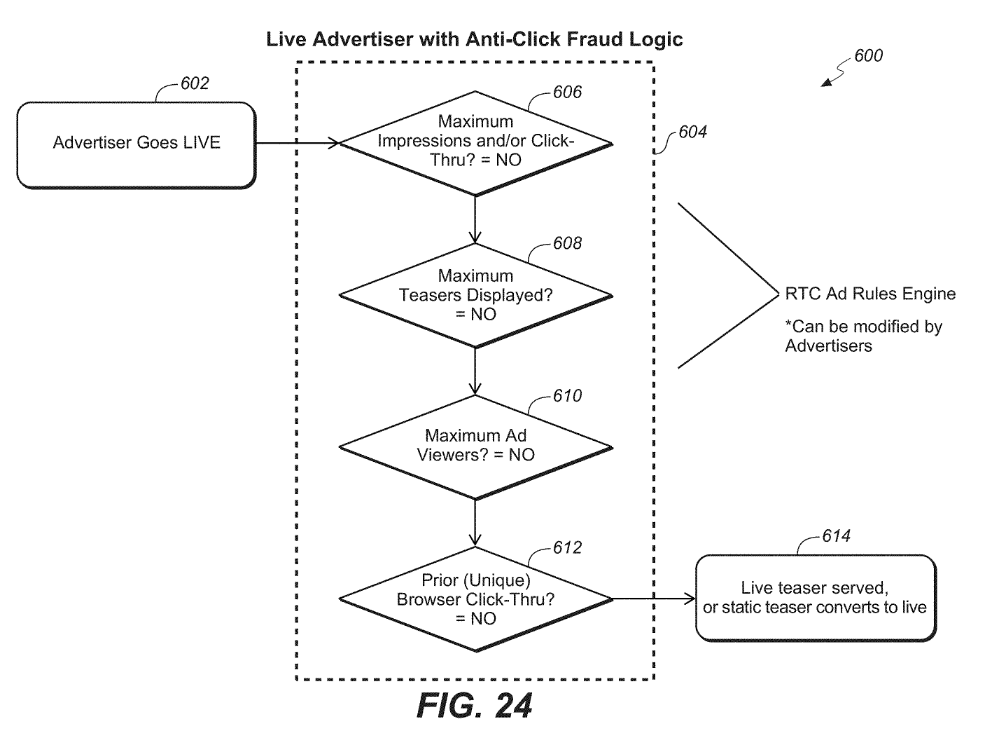

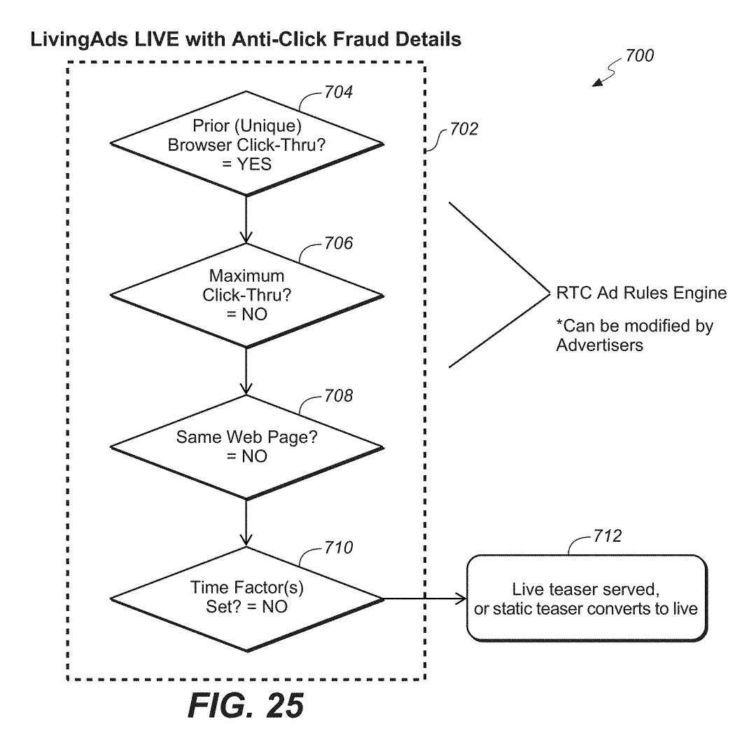

A LivingAd teaser and/or teaser ad status 514 is served 516 to the browser only if it passes this validation check. If not, the teaser will not be served to the browser 518. The anti-click fraud method is adapted for use with both live and static teasers. When selected by an End User, static teasers direct the End User to an associated website (as with conventional ads). When static teasers convert to live teasers, they direct the user to either a dedicated or ephemeral channel; as discussed above. The validation check process is covered in detail in FIGS. 24-25.

Thus, and referring now to FIG. 24, the schematic diagram illustrating the anti-click fraud logic 600 shows the process from the Advertiser going live on its channel, with the first Anti-Click Fraud check, prior to the LivingAd teaser being served. An Advertiser logs into its account and goes live 602 on its channel. The RTC Ad Rules Engine 604, a key component of the LivingAds system, then does its assessment based on the advertiser's settings. The system checks if the maximum amount of impressions and/or click-thrus have been reached 606 based on the Ad Campaign settings. In the illustrated case it has not, so a check is done on whether the maximum number of live teasers displayed has been reached 608 based on Revolving Door settings. In this case it has not, so a check is then done on whether the maximum number of Ad Viewers has been reached 610 based on Revolving Door settings. In the illustrated case it has not, so a check is then done on whether the browser has already visited (via a click-thru) a live teaser 612 based on Anti-Click Fraud settings. It has not in this case, so the LivingAd live teaser is then served 614 or static teaser converts to live.

FIG. 25 illustrates anti-click fraud detail logic showing the process 700 when a browser has already visited (via click-thru) a live teaser. The RTC Ad Rules Engine 702 once again does its assessment; in this specific case based on the advertiser's Anti-Click Fraud settings. In this case, the browser has already selected a live teaser 704. A check is then done on whether the maximum click-thus (per unique browser) has been reached 706. In the illustrated case the advertiser has adjusted its settings to more than one click-thru permitted per unique browser (1 click-thru per live teaser, per unique browser in most cases being the default), so the maximum click-thrus has not been reached, and a check is done on whether the browser is attempting to access the live teaser from the same page 708. By default, a browser can be, for example, permitted to select a live teaser one time on the same web page in a 24 hour period. In this case, the browser is attempting to access the live teaser from a different page so a check is then done on any additional time configurations (e.g. more or less than 24 hours) that may have been set by the advertiser 710. In this case, the Advertiser has not adjusted the default time settings and the LivingAd live teaser is served 712 or static teaser converts to live.

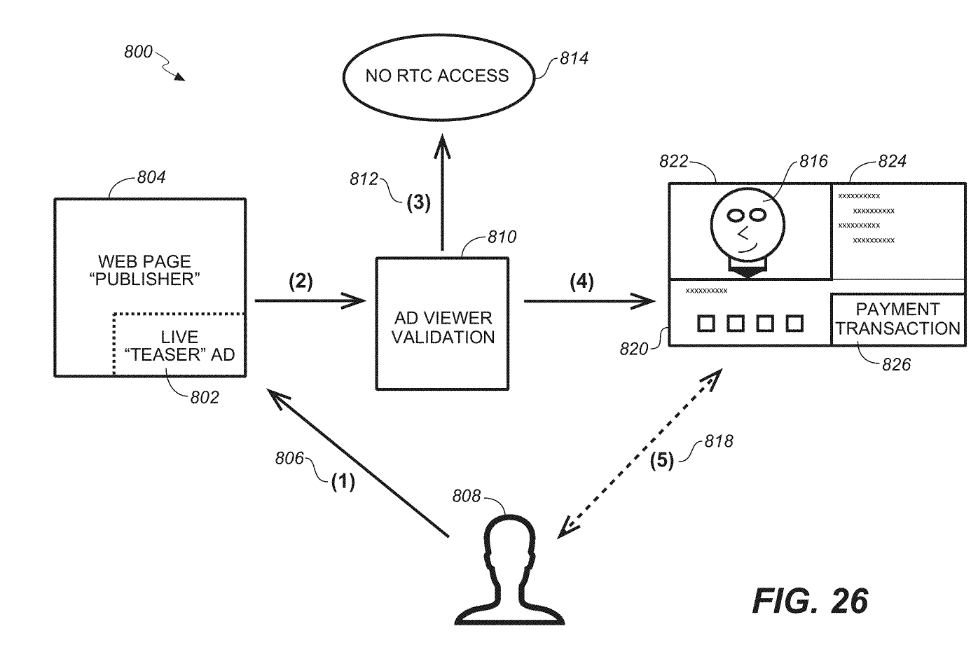

FIG. 26 illustrates another embodiment 800 of the inventive system and method, wherein the LivingAds life cycle includes the following events: (1) A live teaser 802 is displayed, and this is presented on a web page publisher's site 804. (2) A click-thru is triggered 806, meaning that a live teaser ad is selected by the end user 808, which can also include the various Anti-Click Fraud checks indicated in FIG. 24 and FIG. 25. (3) An ad viewer validation check is performed 810; if the end user's response to the advertiser's message is invalid 812, no communications take place 814, but if the response is valid, then . . . (4) The advertiser 816 receives a call initiated by the ad viewer and RTC ensues 818; that is, content 820 is presented to the end user 808 on the advertiser's associated channel 822 (this is the Ad Viewer Validation experience). (4) A confirmation may take place, involving an agreement 824 being reached between the advertiser and the end user (which will naturally vary according to an advertiser's objectives). (5) There is a payment transaction 826, wherein money is exchanged between the advertiser 816 and the end user 808.

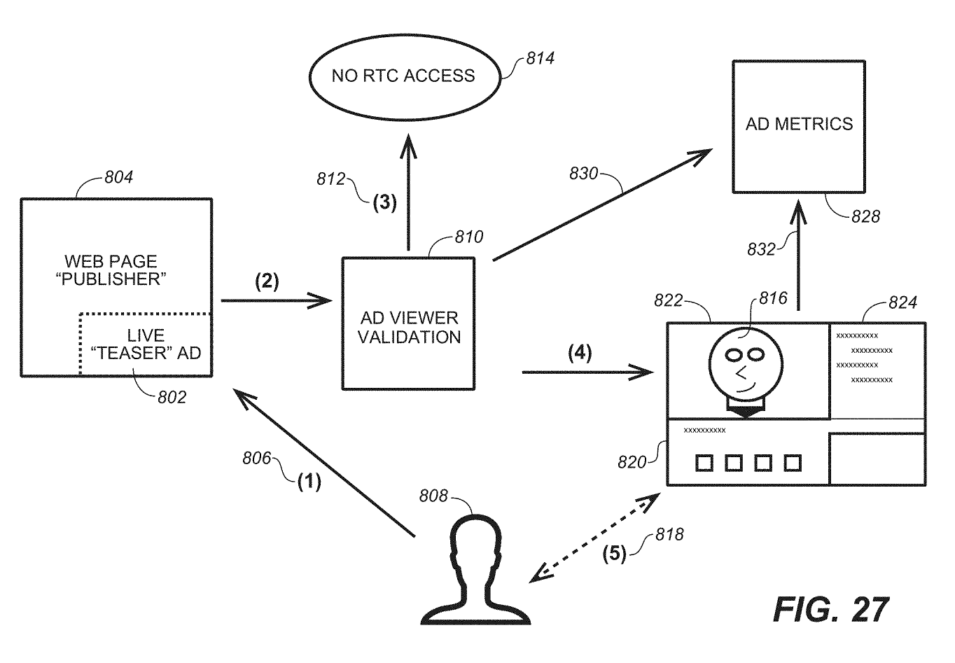

The inventive LivingAds system provides registered Advertisers with powerful ad metrics tools. FIG. 27 schematically illustrates this additional feature 828. Here it is seen that data 830 may be collected during the Ad Viewer Validation step as part of the Ad Metrics analysis (even when the viewer response is invalid). Data generated between the advertiser 816 and ad viewer 808 may also be collected 832 as part of the ad metrics analysis.

Ad metrics may be generated automatically or manually, at the Advertiser's discretion. Auto-generated metrics can be associated with the anti-click fraud features, as well, insofar as an Advertiser may also enable anti-click fraud support and request that the system automatically generate a report of each communication with Ad Viewers, and this feature may affect both live and static teasers, precisely as with anti-click fraud functionality. The ad metrics report includes, but is not limited to, time of live teaser selected, teaser location/publisher (ad placement), length of time of teaser displayed, length of time engaged with ad viewer, cost of teaser ad, close of sale (if applicable), any ad viewer contact information shared, ad viewer questions, and any other pertinent information, or documents, shared. The “Ad viewer validation”, by default, allows the advertiser to prompt the ad viewer with a message that must be responded to prior to any communications. The ad viewer can be prompted with questions via text, voice and/or video (including live video), and they can reply accordingly, utilizing any number of real-time communications techniques. This further helps prevent click fraud and can potentially help the advertiser learn more about the ad viewer, depending on what type of message is presented, prior to any communications. The advertiser can opt out of the ad viewer validation step by deselecting the “Ad Viewer validation” setting. By doing so, the Ad Viewer will have direct communications with the advertiser after selecting the live teaser. Artificial intelligence features can be included to minimize needless human interaction before a suitable degree of validation has been completed. In fact, manual response by the ad viewer in some cases may be unnecessary based on certain behavioral patterns, image recognition (such as facial recognition), and/or other AI-related techniques. AI may be employed productively to determine the reason and priority of an ad viewer's request to communicate with the advertiser. Preferably, this includes a software bot to be used as part of the user validation process. The bot detects incoming user requests and, using Artificial Intelligence, addresses any basic questions. The bot can then hand off communications to a human for more advanced inquiries concerning the advertisement. The Advertiser can intervene during the bot-to-end user communications at any time, and can set triggers (such as key words) for immediate hand off to human interaction established in the RTC Ad Rules Engine.

Ad metrics further includes an “Enable screen sharing” option that allows the Advertiser and Ad Viewer to share screens. This option might not be set as a default because it may involve the ad viewer having to install additional software in order to use this feature. A “Call Center configuration” setting is provided for those advertisers that have call center representatives communicating with the ad viewers and want to have a customized report better suited for this category. A “Generate Report” button can also be provided and when selected, provides all the ad metrics results data based on the Advertiser's settings, in real-time, in an easy-to-read format. This report also includes the Anti-Click Fraud real-time data.

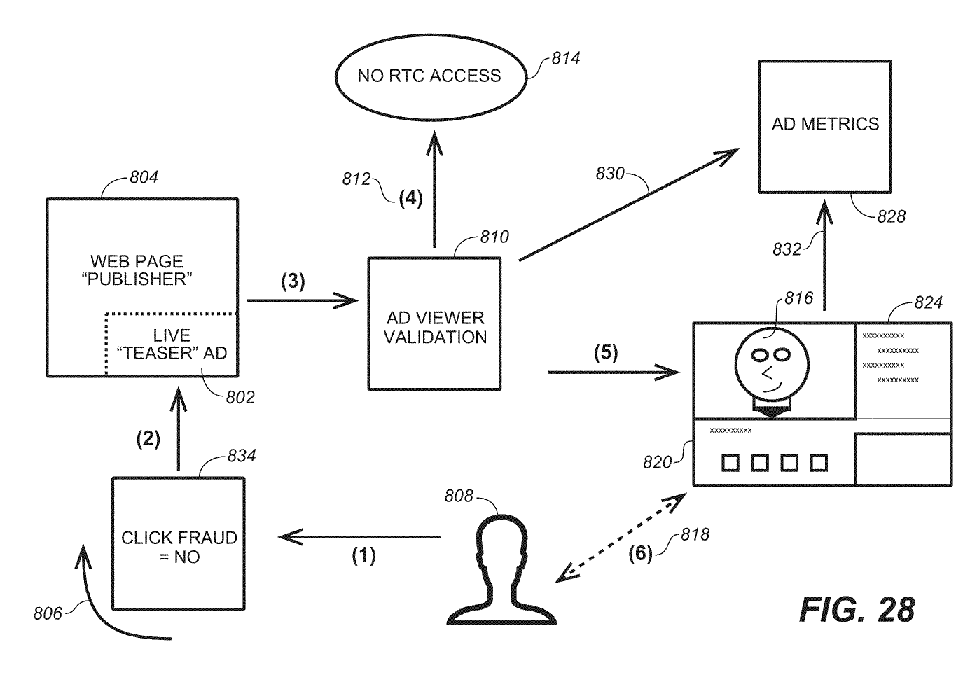

FIG. 28 shows how an anti-click fraud step 834 can be interposed in the click-through feature to prevent click fraud and invalid clicks. The feature and the means for carrying it out are well known and embodied in click fraud firewall, blocking, and monitoring tools.

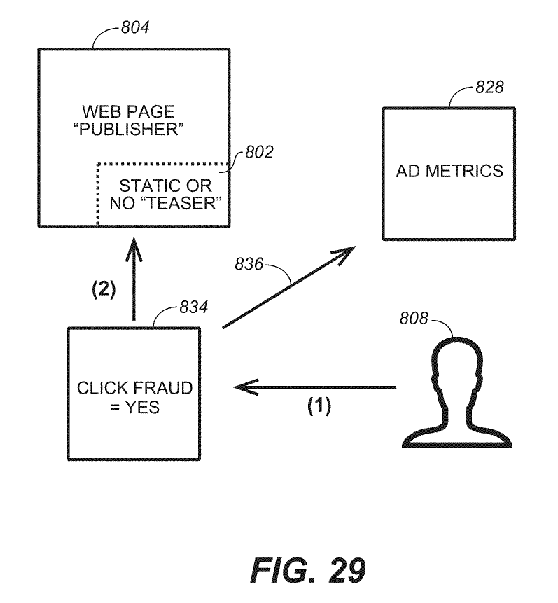

FIG. 29 is a highly simplified schematic flow diagram focusing on a feature of ad metrics 824 which enables the determination of potential click-fraud and/or the collection of click-fraud data 836 prior to live teaser potentially being served, and/or when a click is actually or, at least, potentially occurring. Such data may be valuable for the system to collect. In such circumstances, i.e., when click fraud is actually or potentially occurring, the live teaser 802 is not served. The RTC system with metrics is truly unique in providing a persistent bilateral connection between an end user, advertiser, and Living Ads Network. Depending on the system configuration applied, the duration of this ongoing bilateral connection lasts from the time the end user downloads the publisher's page, which could include a teaser, through exiting the publisher page; or from the time the end user selects the live teaser through, and including, their time spent in the teaser ad's associated channel. This allows for dynamic and ongoing gathering of end user data with or without fraudulent activity. The data is then generated into reports for the Living Ads overall system and individual advertisers based on their RTC Ad Rules Engine settings.

The above disclosure is sufficient to enable one of ordinary skill in the art to practice the invention, and provides the best mode of practicing the invention presently contemplated by the inventor. While there is provided herein a full and complete disclosure of embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative forms, functions, operational features or the like.

Therefore, the above description and illustrations should not be construed as limiting the scope of the invention, which is defined by the appended claims.

What is claimed as invention is:

1. A method of presenting online advertising from a provider to an end user using a network-connected device in a communications network, comprising:
presenting on a publisher's site or channel a self-contained teaser ad to enable real-time communications features and content, wherein the teaser ad is presented in a static state such that it is live only when a channel associated with the advertiser's teaser is live.

2. The method of claim 1, further including prohibiting the teaser ad from going live when the associated channel is set to offline.

3. The method of claim 1, wherein advertisers can accept or deny access to real-time content to any end user based on user profiles or actions.

4. The method of claim 3, wherein when an end user's request to access real-time content is accepted, the teasers can be released at any time to specific end users requesting them.

5. The method of claim 3, further including the step of sending invitations from advertisers to specific end users based on user profiles.

6. The method of claim 1, further including the step of tracking in real-time individual end user behavioral patterns.

7. The method of claim 1, further including the step of providing advertisers with information on end users entering their associated channels.

8. The method of claim 1, further including the step of targeting end users demographically based on user profiles.

9. The method of claim 1, wherein end users can become members of membership-based sites or channels with advertising, and further including the step of providing real-time communications to member end users entering a channel without the need for login, download, installation, or special privileges.

10. The method of claim 1, further including the step of advertisers making real-time adjustments based on individual end user behavioral patterns.

11. The method of claim 10, wherein real-time adjustments include personalizing teasers to specific end users.

12. The method of claim 1, further including the step of presenting teaser ads as a live instant messaging, live audio and/or live video feed.

13. The method of claim 1, wherein the channels may be either dedicated and going live, such that the advertiser engages with an end user in a real-time communication, or one in which the advertiser goes live and engages with the end user in a real-time communication independently of the status of the channel.

14. The method of claim 1, wherein teasers include embedded script that enables the teaser to change from static to live, but only if the advertiser associated with the teaser goes live.

15. The method of claim 1, further including the step of using incentive advertising to enable advertisers to reward end users for participating in promotional teaser ads with real-time contests and games.

16. The method of claim 15, further including the step of presenting prizes to end users in real-time, during an ad gamification event based on end user actions.

17. The method of claim 16, wherein end user actions that trigger prize winning are predetermined and set by the advertising using advertiser settings and a real-time communications engine.

18. The method of claim 16, wherein end user actions that trigger prize winning are real-time, dynamic decisions made by the advertiser during the live ad gamification event.

19. The method of claim 15, wherein the interactive advertising includes ad gamification with telepresence.

20. The method of claim 19, wherein the end viewer participant remotely controls a device associated with the teaser.

21. The method of claim 1, further including an anti-click fraud step in which an advertiser's teaser ad status is served to an end user's browser only if it passes a validation check.
